(19) United States
(12) Patent Application Publication
(10) Pub. No.: US 2010/0323682 A1
(43) Pub. Date: Dec. 23, 2010

(54) COMMUNICATION METHOD AND, TERMINAL APPARATUS AND BASE STATION APPARATUS USING THE METHOD

(76) Inventors: Yoshinori Hatayama, Aichi (JP); Hiroshi Takemura, Aichi (JP); Kazuya Ogawa, Gifu (JP); Yoko Tanaka, Gifu (JP); Yasukazu Kamei, Nara (JP)

Correspondence Address: MCDERMOTT WILL & EMERY LLP, 600 13TH STREET, N.W., WASHINGTON, DC, 20005-3096, US

(21) Appl. No.: 12/446,380

(22) PCT Filed: Oct. 17, 2007
(86) PCT No.: PCT/JP2007/001128

§ 371 Date: Jun. 29, 2009

(30) Foreign Application Priority Data
Oct. 18, 2006 (JP) 2006-284427

(51) Int. Cl. H04W 4/00

(52) U.S. Cl. 455/422.1

(57) ABSTRACT

A wide area network (50) connects a WLAN base station apparatus (60) and a content supply apparatus (510). The content supply apparatus (510) stores communication contents prepared in a broadcasting format. The WLAN base station apparatus (60) acquires and stores contents from the content supply apparatus (510) through the wide area network (50). The WLAN base station apparatus (60) converts the format of the contents to be distributed and distributes the converted contents using a WLAN method. The WLAN base station apparatus (60) transmits connection setting information and content information to an information distribution apparatus (520). The connection setting information includes information for connection of the terminal apparatus (30) to the WLAN base station apparatus (60). A terminal apparatus (30) acquires the connection setting information and the content information from the information distribution apparatus (520). The terminal apparatus (30) carries out a connection processing to connect with the WLAN base station apparatus (60), using the acquired connection setting information.

### BACKGROUND OF THE INVENTION

1. Technical Field

The present invention relates to a communication technology, and in particular to a communication method within a wireless network, a terminal apparatus using the method, and a communication system.

2. Background Technology

In recent years, it has become possible to obtain broadcast contents, such as television broadcasts and radio broadcasts, using personal computers. However, with the use of personal computers, it has been only possible to obtain such broadcast contents at limited locations such as a user's home. Therefore, mobile phones that can be carried around have been put to use in obtaining broadcast contents wherever a user is located (see Patent Document 1, for instance). Also, mobile phones have been used in obtaining broadcast contents by accessing a server capable of receiving data from a distribution apparatus installed in a train or at other specific locations (see Patent Document 2, for instance).

[Patent Document 1] Japanese Patent Application Laid-Open No. 2002-164860.

[Patent Document 2] Japanese Patent Application Laid-Open No. 2005-203911.

### DISCLOSURE OF THE INVENTION

### Problems to be Solved by the Invention

Some of the mobile phones have a function of receiving broadcast waves and decoding signals prescribed for broadcasting. In the cases where broadcast contents are to be distributed to such mobile phones through a communication network such as an IP (Internet Protocol) network, there exists a difference between the communication format using a medium of the IP network and the broadcast format using broadcast waves. This requires a terminal apparatus to have therewithin not only a function of decoding data in broadcast format but also a new function of decoding data in communication format.

The present invention has been made in view of these circumstances, and a general purpose thereof is to provide a technology that allows an easy acquisition of contents.

### Means for Solving the Problems

In order to resolve the foregoing problems, a terminal apparatus according to one embodiment of the present invention comprises: a receiver which receives communication data in a format prescribed in a communication system, from a base station apparatus in the communication system; and a reproduction unit which reproduces broadcast data in a format prescribed for broadcasting in another broadcasting system which differs from the communication system. The communication data received by the receiver contains the broadcast data; and the reproduction unit extracts the broadcast data from the communication data received by the receiver and reproduces the extracted broadcast data.

Here, the “base station apparatus in the communication system” includes access points in a WLAN (Wireless Local Area Network) system. Also, the “format prescribed in a communication system” includes a data format in a physical layer or MAC (Media Access Control) layer standardized in IEEE 802.11, for instance. Also, the “format prescribed for broadcasting” includes the format of TS packet prescribed in MPEG-2 TS (Moving Picture Expert Group-2 Transport Stream), for instance, and other formats.

According to this embodiment, the data containing the contents of a format prescribed for broadcasting and reproducible by terminal apparatuses at a reproduction side are distributed at a distribution side through a communication system different from a broadcasting system. And, in the terminal apparatuses at the reproduction side, data in a format prescribed for broadcasting are extracted from the received data and then the extracted data are reproduced. As a result, the terminal apparatuses can reproduce the contents easily.

A terminal apparatus may further comprise: an acquiring unit which acquires connection information with which to connect to the base station, from a communication apparatus; and a connection processing unit which establishes a connection to the base station apparatus, using the connection information acquired by the acquiring unit, wherein after the connection has been established by the connection processing unit, the receiver may receive the communication data from the base station apparatus. The acquiring unit may acquire the connection information broadcast from the communication apparatus. Also, the communication apparatus and the base station apparatus may be separate units.

Here, the communication apparatus includes a short-distance radio apparatus using infrared communication and an access point in WLAN (Wireless Local Area Network) system. According to this embodiment, the connection information with which to connect to the base station apparatus is acquired from the communication apparatus which is different from the base station apparatus, so that the connection information can be easily acquired.

The connection information acquired by the acquiring unit is included in information transmitted from the communication apparatus. In this case, the connection information is included in the information transmitted from the communication apparatus, so that the connection processing can be easily achieved.

Another embodiment of the present invention relates also to a terminal apparatus. This apparatus comprises: an acquiring unit which acquires connection information with which to establish a connection between the terminal apparatus and a base station apparatus wherein the connection information has been transmitted from a communication apparatus; a connection processing unit which carries out a connection processing between the terminal apparatus and the base station apparatus, using the connection information acquired by the acquiring unit; and a receiver which receives communication data from the base station apparatus after the connection processing by the connection processing has been completed. According to this embodiment, the connection information with which to connect to the base station apparatus different from the communication apparatus is acquired from this communication apparatus, so that the connection information can be easily acquired.

The connection information acquired by the acquiring unit may contain area information on an area where the terminal apparatus is located, and the receiver may switch the communication data to be received, according to the area information acquired by the acquiring unit. According to this embodiment, the terminal apparatus can easily acquire the contents that differ for each area.

The communication data received by the receiver may be encrypted by an encryption key, and the acquiring unit may receive, from the communication apparatus, a decryption key for decrypting said communication data. According to this embodiment, the terminal apparatus can safely acquire the contents that differ for each area.

Still another embodiment of the present invention relates to a communication system. This communication system comprises: a base station apparatus which transmits communication data; a communication apparatus which broadcasts connection information with which to connect to the base station apparatus; and a terminal apparatus which carries out a connection processing between the terminal apparatus and the base station apparatus according to the connection information transmitted from the communication apparatus and which acquires communication data from the connected base station apparatus. In this case, the terminal apparatus can reliably perform the connection processing between the terminal apparatus and a base station apparatus to be connected.

Still another embodiment of the present invention relates to a communication method. This method is such that communication data in a format prescribed in a communication system are received from a base station apparatus in the communication system, the communication data containing broadcast data in a format prescribed for broadcasting in another broadcasting system which differs from the communication system, the broadcast data are extracted from the received communication data, and the extracted broadcast data are reproduced.

Still another embodiment of the present invention relates also to a communication method. This method is such that connection information transmitted from a communication apparatus is acquired, the connection information being used to establish a connection to a base station apparatus different from the communication apparatus, a connection processing with the base station apparatus is carried out using the acquired connection information, and communication data are received from the base station apparatus after the connection processing has been completed.

Optional combinations of the aforementioned constituting elements, and implementations of the invention in the form of methods, apparatuses, systems, recording mediums, computer programs and so forth may also be effective as additional modes of the present invention.

### EFFECT OF THE INVENTION

The present invention enables an easy acquisition of contents.

### BRIEF DESCRIPTION OF THE DRAWINGS

FIG. 1 is a diagram showing an exemplary structure of a communication system according to an embodiment of the present invention.

FIG. 2 is a diagram showing an exemplary structure of a WLAN base station apparatus of FIG. 1.

FIGS. 3(a) to 3(d) are diagrams to show examples of conversion processing on the format of contents.

FIG. 4 is a diagram showing an exemplary structure of an information distribution apparatus of FIG. 1.

FIG. 5 is a diagram showing an exemplary structure of a terminal apparatus of FIG. 1.

FIGS. 6(a) and 6(b) are diagrams showing examples of connection setting information and content information according to a first modification, respectively.

FIG. 7 is a diagram showing an exemplary structure of a content processing unit 1030 of FIG. 5.

FIG. 8 is a sequence diagram showing an example of connection processing of a communication system of FIG. 1.

FIG. 9 is a flowchart showing an exemplary operation of a terminal apparatus of FIG. 1.

FIG. 10 is a diagram showing an exemplary structure of a first distribution system according to a first modification.

FIGS. 11(a) and 11(b) are diagrams showing examples of content information and AP information, respectively, according to a first modification.

FIG. 12 is a diagram showing an exemplary structure of a content distribution apparatus of FIG. 10.

FIG. 13 is a diagram showing an exemplary structure of an AP of FIG. 10.

FIG. 14 is a flowchart showing an exemplary operation of a first distribution system of FIG. 10.

FIG. 15 is a flowchart showing an exemplary operation of a terminal apparatus of FIG. 10.

FIG. 16 is a flowchart showing an exemplary operation of an AP of FIG. 10.

FIG. 17 is a diagram showing an exemplary structure of a second distribution system according to a second modification.

FIGS. 18(a) and 18(b) are diagrams showing examples of content information and information distribution apparatus information, respectively, according to a second modification.

FIG. 19 is a diagram showing an exemplary structure of an information distribution apparatus of FIG. 17.

FIG. 20 is a diagram showing an exemplary structure of a terminal apparatus of FIG. 17.

FIG. 21 is a flowchart showing an exemplary operation of a terminal apparatus of FIG. 17.

FIGS. 22(a) and 22(b) are diagrams showing examples of content information and information distribution apparatus information in a third modification.

FIG. 23 is a diagram showing an exemplary structure of a content distribution apparatus according to the third modification.

FIG. 24 is a diagram showing an exemplary structure of an AP according to a third modification.

FIG. 25 is a flowchart showing an exemplary operation of a terminal apparatus according to a third modification.

FIG. 26 is a diagram showing an example of privileged content information in a fourth modification.

FIG. 27 is a diagram showing an exemplary structure of a terminal apparatus according to a fourth modification.

FIG. 28 is a diagram showing an exemplary structure of a privileged information distribution apparatus according to a fourth modification.

FIG. 29 is a diagram showing an exemplary structure of a fifth distribution system according to a fifth modification.

FIG. 30 is a diagram showing an exemplary structure of a terminal apparatus of FIG. 29.

FIG. 31 is a diagram showing an exemplary structure of a WLAN base station apparatus of FIG. 29.

FIG. 32 is a diagram showing an exemplary operation of a terminal apparatus of FIG. 29.

FIG. 33 is a diagram showing an exemplary structure of a sixth distribution system according to a sixth modification.

FIG. 34 is a diagram showing an example of control information according to a sixth modification.

FIG. 35 is a diagram showing an exemplary structure of a content distribution apparatus of FIG. 33.

FIG. 36 is a diagram showing an exemplary structure of a fixed terminal apparatus of FIG. 33.

FIG. 37 is a diagram showing an exemplary structure of a terminal apparatus of FIG. 33.

FIG. 38 is a diagram showing an exemplary structure of a positional information setting apparatus of FIG. 33.

FIG. 39 is a diagram showing an exemplary structure of a seventh distribution system according to a seventh modification.

FIG. 40 is a diagram showing an exemplary structure of a content distribution apparatus of FIG. 39.

FIG. 41 is a diagram showing an exemplary structure of a terminal apparatus of FIG. 39.

FIG. 42 is a diagram showing an exemplary structure of an originating terminal apparatus of FIG. 39.

FIG. 43 is a diagram showing an exemplary structure of an eighth distribution system according to an eighth modification.

FIG. 44 is a diagram showing an exemplary structure of a content distribution apparatus of FIG. 43.

FIG. 45 is a diagram showing an exemplary structure of a terminal apparatus of FIG. 43.

FIG. 46 is a diagram showing an exemplary structure of a ninth distribution system according to a ninth modification.

FIG. 47 is a diagram showing an exemplary display of screen of a terminal apparatus of FIG. 46.

FIG. 48 is a diagram showing an exemplary structure of a content distribution apparatus of FIG. 46.

FIG. 49 is a diagram showing an exemplary structure of a terminal apparatus of FIG. 46.

FIG. 50 is a diagram showing an exemplary structure of an originating terminal apparatus of FIG. 46.

FIG. 51 is a diagram showing an exemplary structure of a tenth distribution system according to a tenth modification.

FIG. 52 is a diagram showing an exemplary structure of an external control server and a content distribution apparatus of FIG. 51.

### DESCRIPTION OF THE REFERENCE NUMERALS

30 Terminal apparatus, 50 Wide area network, 60 WLAN base station apparatus, 100 Communication system, 110 TS packet, 120 Time stamp, 122 Header information, 200 Recording format, 210 Broadcasting format, 220 Communication format, 510 Content supply apparatus, 520 Information distribution apparatus, 530 AP, 540 Content distribution apparatus.

### BEST MODE FOR CARRYING OUT THE INVENTION

An outline of the present invention will be given before a specific description thereof. The present embodiment relates to a communication system for distributing communication contents, such as advertising information and the like, to terminal apparatuses. The communication system includes a terminal apparatus, a WLAN base station apparatus, a server, and an information distribution apparatus. The terminal apparatus herein may be a mobile phone or a PDA (Personal Digital Assistant), for instance.

In recent years, the marked advancement of communication functions of terminal apparatuses is realizing a variety of communication connectivity of terminal apparatuses which are equipped not only with a cellular network communication means but also with a short-distance wireless function using infrared radiation or the like, a receiving module for terrestrial digital television broadcasts (hereinafter referred to as “One-Seg” or “one-segment broadcasting”) for mobile terminals, or WLAN connection function. On the other hand, the widespread use of the Internet is preparing an environment in which anybody can transmit advertising information and the like on the Internet, thus diversifying the advertising business. Yet, the advertising information and the like are primarily intended for browsing by personal computers and not for easy viewing by anyone anywhere. Hence, it is desired that an environment will be created in which the advertising information and the like can be delivered by broadcasting to portable mobile phones carried around by an extremely high percentage of people.

However, it is difficult to distribute advertising information and the like by broadcasting. The reason is that broadcasting involves licensing and structuring broadcasting facilities is not easy, which means that broadcasts are not something anybody can transmit freely. For this reason, the use of broadcast waves is not appropriate when contents, such as independently produced advertising information, are to be distributed within a desired area.

On the other hand, contents are often produced and stored in a format prescribed for broadcasting (hereinafter referred to as “broadcasting format”), such as TS format, for broadcasting in a broadcasting system. Here, if advertising information is to be distributed to terminal apparatuses not on broadcast waves but over a communication network such as an IP (Internet Protocol) network, it will be necessary that a terminal apparatus has both a function of decoding data in broadcasting format of broadcast waves and the function of decoding data in distribution format over the IP network. This is because there is a difference between the data format for distribution through the IP network and the broadcasting format. Hence, there will be an extremely large burden on a terminal apparatus, which is subject to limited hardware resources.

Therefore, advertising information and the like to be distributed to terminal apparatuses are produced and stored in a broadcasting format and, when it is to be distributed, converted into data in a format prescribed for communication. Also, the present embodiment employs an arrangement such that a connection processing can be accomplished easily by autonomously transmitting to a terminal apparatus connection information for connection to a communication apparatus of a distribution source. This communication system is suited for installation in retail stores and the like.

As will be described in detail later, the communication system is so configured that advertising information and the like are distributed from a WLAN communication apparatus installed in the store. Also, a short-distance radio apparatus, which is different from the WLAN communication apparatus as a distribution source, is installed near the entrance to the retail store, and connection setting information with which to connect to the WLAN communication apparatus is transmitted from the short-distance radio apparatus to the terminal apparatus. When the user is inside the retail store, information necessary to receive the retail store's own communication contents is transmitted over a short-distance radio network formed by the short-distance radio apparatus. The terminal apparatus makes a connection to the WLAN communication apparatus based on the information transmitted thereto, and now the user can view and listen to the communication contents. The communication contents to be delivered in the retail store may be advertising information concerning a new product campaign and the like. Such a mode of application enables the user to easily acquire communication contents such as advertising information and campaign information.

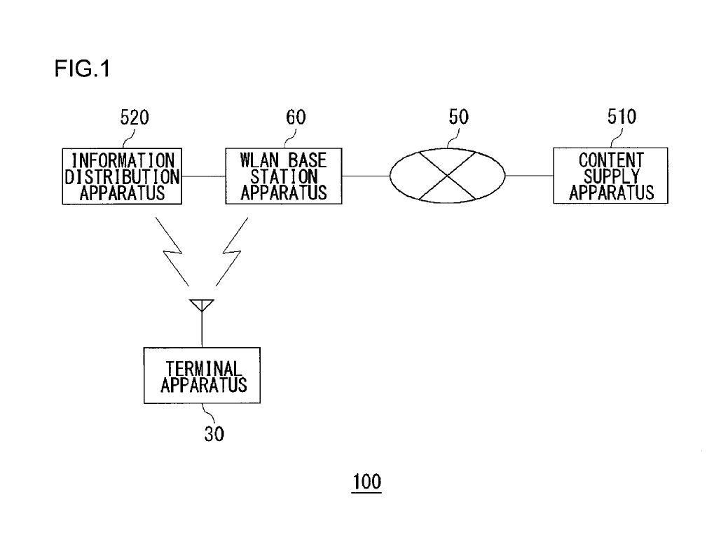

FIG. 1 is a diagram showing an exemplary structure of a communication system 100 according to an embodiment of the present invention. The communication system 100 includes a terminal apparatus 30, a wide area network 50, a content supply apparatus 510, a WLAN base station apparatus 60, and an information distribution apparatus 520.

The wide area network 50 connects the WLAN base station apparatus 60 and the content supply apparatus 510. The content supply apparatus 510 stores communication contents prepared in a broadcasting format. Data of the communication contents to be distributed by the WLAN base station apparatus 60 are uploaded through the wide area network 50.

The WLAN base station apparatus 60 acquires and stores the contents from the content supply apparatus 510 through the wide area network 50. The WLAN base station apparatus 60 converts the format of the contents to be distributed and distributes the converted contents using a WLAN method. The WLAN base station apparatus 60 transmits connection setting information and content information to the information distribution apparatus 520. The connection setting information includes information with which to connect the terminal apparatus 30 to the WLAN base station apparatus 60. The content information includes a list of contents that can be distributed. In the list, identification information indicating the respective contents is associated with IP addresses from which the contents are distributed and the like.

The information distribution apparatus 520 is installed in an area inside a retail store where the terminal apparatus 30 is supposed to perform a connection processing to connect to the WLAN base station apparatus 60, for example, near the entrance to the retail store. The information distribution apparatus 520 is in wired or wireless connection to the WLAN base station apparatus 60. The information distribution apparatus 520 receives connection setting information and content information from the WLAN base station apparatus 60 and transmits the received connection setting information and content information to the terminal apparatus 30.

The terminal apparatus 30 acquires broadcast contents by receiving broadcast waves from a not-shown broadcasting station. The terminal apparatus 30 acquires connection setting information and content information from the information distribution apparatus 520. The terminal apparatus 30 carries out a connection processing to connect with the WLAN base station apparatus 60, using the acquired connection setting information. The terminal apparatus 30 changes the setting of communication means so as to receive the contents by using the acquired content information. The terminal apparatus 30 receives the communication contents sent from the WLAN base station apparatus 60 and converts the format of the received communication contents into a reproducible broadcasting format. Further, the terminal apparatus 30 displays or outputs the communication contents whose format has been converted. Note that the information distribution apparatus 520 may be so configured as to acquire the connection setting information and content information not from the WLAN base station apparatus 60 but from the content supply apparatus 510.

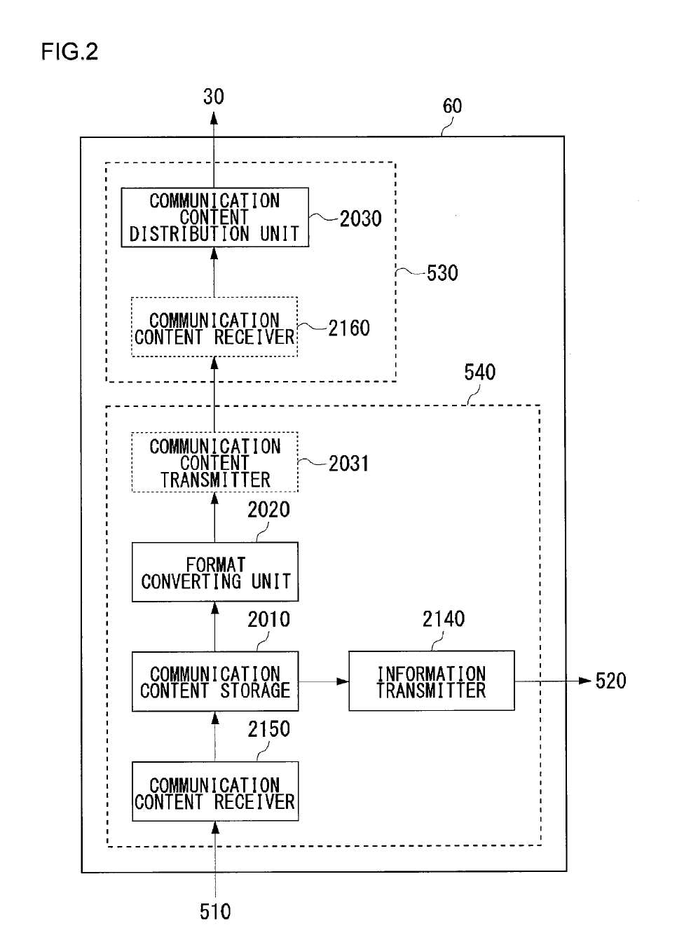

FIG. 2 is a diagram showing an exemplary structure of a WLAN base station apparatus 60 of FIG. 1. The WLAN base station apparatus 60 is comprised of a content distribution apparatus 540 and an AP (Access Point) 530, which are both delineated with a broken line. The content distribution apparatus 540 is a device for receiving contents from the content supply apparatus 510 and transmitting them to the AP 530. The AP 530 is a device for delivering the contents sent from the content distribution apparatus 540 to the terminal apparatus 30. Although, in FIG. 1 and FIG. 2, the content distribution apparatus 540 and the AP 530 are installed inside the same WLAN base station apparatus 60, the arrangement may be such that the content distribution apparatus 540 and the AP 530 are present as separately installed units. Also, where the distribution area is wide, the delivery of communication contents can be made possible by installing additional units of the AP 530 only. Also, where communication contents are distributed by a unicast or such other system that places a heavy burden on the distributing side, attempts may be made to disperse the burden or reduce the delay in distribution by providing a plurality of APs 530. In the following description, therefore, the content distribution apparatus 540 and the AP 530 may be separately installed units as applicable.

In FIG. 2, the content distribution apparatus 540 includes a communication content receiver 2150, a communication content storage 2010, a format converting unit 2020, and an information transmitter 2140. The AP 530 includes a communication content distributing unit 2030. Where the content distribution apparatus and the AP are separately installed units, the components indicated by a dotted line are included. That is, the content distribution apparatus further includes a communication contents transmitter 2031 for delivering contents to the AP, and the AP 530 is further equipped with a communication content receiver 2150 for receiving contents delivered from the content distribution apparatus 540.

The communication content receiver 2150 receives communication contents transmitted from the content supply apparatus 510. The received communication contents are stored in the communication contents storage 2010.

The communication content storage 2010 stores communication contents that are acquired from the content supply apparatus 510 and delivered to users within the store. The communication content storage 2010 stores connection setting information with which to connect to its own WLAN base station apparatus 60 and content information concerning communication contents to be distributed.

The format converting unit 2020 acquires communication contents stored in the communication content storage 2010, performs a conversion processing on the format thereof, and then outputs the converted communication contents to the communication content transmitter 2031.

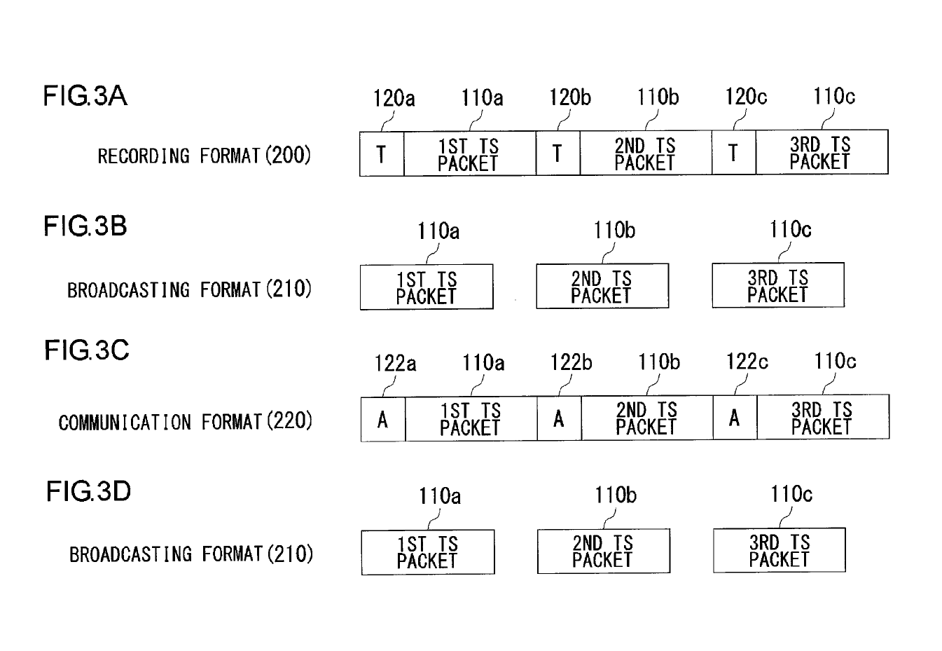

Here the conversion processing is explained in concrete terms. FIGS. 3(a) to 3(d) are diagrams to show examples of conversion processing on the format of contents. FIG. 3(a) shows a recording format 200. The recording format 200 is the format of contents transmitted from the content supply apparatus 510 to the WLAN base station apparatus 60 and held by the communication content storage 2010. The recording format 200 contains a first TS packet 110a to a third TS packet 110c, which are represented by “TS packet 110”, and a first time stamp 120a to a third time stamp 120c, which are represented by “time stamp 120”.

The format converting unit 2020 acquires contents of the recording format 200 stored in the communication content storage 2010 and converts the format thereof into a broadcasting format 210 when the time stamp 120 contained in the recording format 200 coincides with the clock counter of the format converting unit 2020. The clock frequency of the format converting unit 2020 may be 27 MHz, for instance. FIG. 3(b) is a diagram showing the broadcasting format 210. The broadcasting format 210 contains TS packets 110.

Then the format converting unit 2020 converts the format into a communication format 220 which is suited to a communication in the broadcasting format 210. FIG. 3(c) shows a communication format. The communication format 220 contains header information 122 and TS packets 110. The header information 122 contains header information concerning UDP (User Datagram Protocol) (this header information will be hereinafter referred to as “UDP header information”). Hereinbelow, packets designated by the communication format 220 will be referred to as IP packets. Here, the TS packets 110 are located posterior to their respective time stamps 120. In other words, the IP packets are so structured that header information 122 is located anterior to their respective TS packets 110. Note that while three TS packets 110 are shown here for convenience of illustration, there may be less than three or four or more TS packets 110 involved. FIG. 3(d) will be described later.

Referring back to FIG. 2, the communication content distributing unit 2030 distributes communication contents received from the format converting unit 2020. The information transmitter 2140 transmits connection setting information and content information stored in the communication content storage 2010 to the information distribution apparatus 520.

Note that where the content distribution apparatus 540 and the AP 530 are separately installed units, a communication content transmitter 2031 and a communication content receiver 2060, which are both not shown, are present to provide a relay from the format converting unit 2020 to the communication content distributing unit 2030. In other words, communication contents outputted from the format converting unit 2020 provided in the content distribution apparatus 540 are transmitted by the communication content transmitter 2031 to the AP 530. And they are received by the communication content receiver 2060 provided in the AP 530 and sent to the communication content distributing unit 2030.

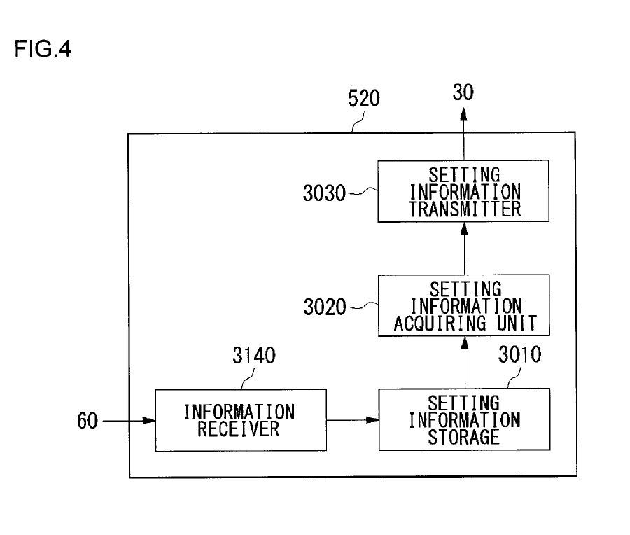

FIG. 4 is a diagram showing an exemplary structure of the information distribution apparatus 520 of FIG. 1. The information distribution apparatus 520 includes a setting information storage 3010, a setting information acquiring unit 3020, a setting information transmitter 3030, and an information receiver 3140. The information receiver 3140 receives connection setting information and content information transmitted from the WLAN base station apparatus 60. The setting information storage 3010 holds the connection setting information and content information received by the information receiver 3140. The setting information acquiring unit 3020 acquires the connection setting information and content information held by the setting information storage 3010. The setting information acquiring unit 3020 sends the acquired connection setting information and content information to the setting information transmitter 3030. In answer to a request from the setting information acquiring unit 3020, the setting information transmitter 3030 transmits the content information to the terminal apparatus 30 connected to the information distribution apparatus 520.

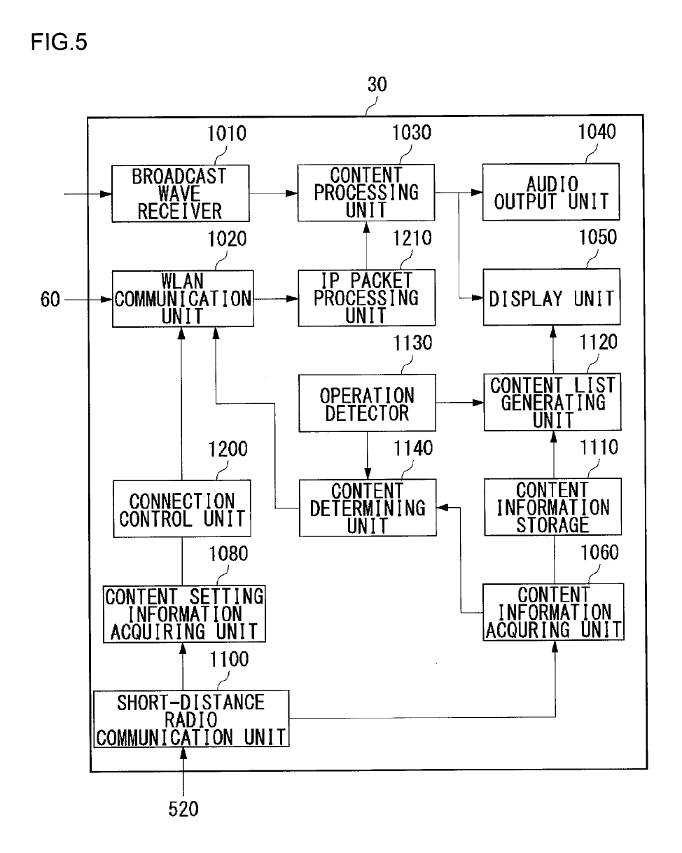

FIG. 5 is a diagram showing an exemplary structure of the terminal apparatus 30 of FIG. 1. The terminal apparatus 30 includes a broadcast wave receiver 1010, a WLAN communication unit 1020, a content processing unit 1030, an audio output unit 1040, a display unit 1050, a content information acquiring unit 1060, a connection setting information acquiring unit 1080, a short-distance radio communication unit 1100, a content information storage 1110, a content list generating unit 1120, an operation detector 1130, a content determining unit 1140, a connection control unit 1200, and an IP packet processing unit 1210.

The short-distance radio communication unit 1100 receives connection setting information and content information transmitted from the information distribution apparatus 520 through a short-distance radio network. The received connection setting information is sent to the connection setting information acquiring unit 1080. And the received content information is sent to the content information acquiring unit 1060. The content information acquiring unit 1060 stores the content information sent from the short-distance radio communication unit 1100 in the content information storage 1110. The content information includes information concerning initial content, which will be discussed later. Based on the acquired content information, the content information acquiring unit 1060 sends the content information concerning initial content to the content determining unit 1140, thereby requesting it to determine the communication contents as the received contents.

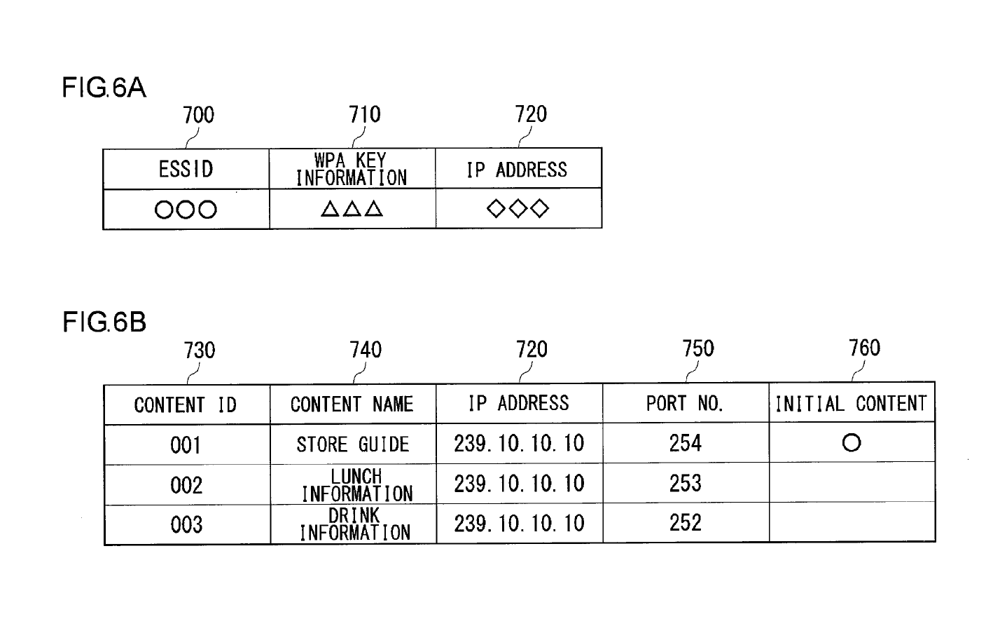

Here the connection setting information and content information are explained in concrete terms. FIGS. 6(a) and 6(b) are diagrams to show examples of connection setting information and content information according to the present embodiment, respectively. FIG. 6(a) shows an example of connection setting information, which includes an ESSID (Extended Service Set ID) column 700, a WPA (WiFi Protected Access) key information column 710, and an IP address column 720. Shown in the ESSID column is an ESSID. The ESSID is used in determining the WLAN base station apparatus 60 to be connected. Shown in the WPA key information column 710 is WPA key information. The WPA key information is information on an encryption key which is used in the connection to the WLAN base station apparatus 60.

FIG. 6(b) shows an example of content information. The content information includes content IDs shown in a content ID column 730, content names shown in a content name column 740, IP addresses shown in an IP address column 720, port numbers shown in a port No. column 750, and information on initial content shown in an initial content column 760.

The content ID is an identifier for identification of a communication content. The content name is a name of the communication content. The IP address and the port No. are a multicast address and a port No. respectively for distribution of the communication content. The initial content is a content that is received initially after the establishment of connection. As shown, the content indicated by “circle” in the initial content column 760 is the initial content.

Referring back to FIG. 5, the content information storage 1110 stores content information acquired by the content information acquiring unit 1060. The content information thus stored is referenced by the content list generating unit 1120. Based on the content information stored in the content information storage 1110, the content list generating unit 1120 generates a list of communication contents that can be received audio-visually. The content list generating unit 1120 also causes the generated content list to be displayed by the display unit 1050.

The operation detector 1130 is an interface through which instructions from the user are received. The operation detector 1130 detects operations executed by the user on the terminal apparatus 30. When the user has requested a display of a content list, the operation detector 1130 requests the content list generating unit 1120 to generate a content list. When the user has selected a communication content, the operation detector 1130 requests the content determining unit 1140 to determine the selected content to be the content to be viewed and listened to.

The content determining unit 1140 determines a communication content to be viewed and listened to, based on a request from the content information acquiring unit 1060 or the operation detector 1130. The content determining unit 1140 performs a setting of the WLAN communication unit 1020 such that the communication content thus determined can be received. The connection setting information acquiring unit 1080 acquires connection setting information received by the short-distance radio communication unit 1100. The connection setting information acquiring unit 1080 also sends the acquired connection setting information to the connection control unit 1200.

The connection control unit 1200 compares the ESSID contained in the connection information received by the short-distance radio communication unit 1100 against the ESSID transmitted in a beacon frame or the like from each AP and acquired by the WLAN communication unit 1020, and establishes connection with a pertinent AP upon finding agreement.

Note that in the case where there are a plurality of APs that have shown agreement with the ESSID contained in the received connection information, a processing such as automatically selecting the AP showing the highest receiving strength may be performed. Also, where the same business operator has a plurality of stores, the arrangement may be such that a specific value of ESSID is set for all the stores and the ESSID is set in the terminal apparatus 30 in advance. Or, alternatively, the arrangement may be such that the specific ESSID can be registered through an operation by the user. Such an arrangement may realize a configuration that has no need for an information distribution apparatus. Also, where key information is necessary as a condition for connection with the WLAN base station apparatus 60, the connection control unit 1200 connects to the WLAN base station apparatus 60 using WPA key information.

The broadcast wave receiver 1010 includes an antenna and a One-Seg tuner. The antenna receives broadcast waves containing a broadcast content broadcast by a not-shown broadcasting station and outputs them to the One-Seg tuner. The One-Seg tuner, which has received the input from the antenna, performs receiving processings, such as frequency conversion processing, A/D (Analog/Digital) conversion processing, demodulation processing, and error correction decoding processing, on the broadcast waves. After that, the One-Seg tuner outputs signals containing the receiving-processed broadcast content to the content processing unit 1030. Included in the “signals containing the broadcast content” outputted to the content processing unit 1030 are TS packets.

The WLAN communication unit 1020 receives a communication content distributed from the WLAN base station apparatus 60. The WLAN communication unit 1020 performs a demodulation processing and the like on the received content. The demodulated content is sent to the IP packet processing unit 1210 so as to be processed thereby.

Specifically, a frequency conversion processing, an A/D conversion processing, various demodulation processings, and an error correction decoding processing are performed on the received communication content so as to acquire IP packets. The format of the acquired IP packets is, for example, the communication format 220 shown in FIG. 3(c).

The IP packet processing unit 1210 extracts TS packets from the IP packets acquired by the WLAN communication unit 1020. The IP packet processing unit 1210 carries out a processing reverse to the aforementioned conversion at the content supply apparatus 510. In other words, the IP packet processing unit 1210 generates desired TS packets by decomposing the acquired IP packets successively. For the generation of TS packets, there may additionally be a function for outputting the TS packets stably by performing a buffering or the like. The packets thus generated are outputted to a Demux unit 90.

An explanation will be given concretely below. For example, when it has received a format such as the communication format 220 of FIG. 3(c), the IP packet processing unit 1210 preferably performs a processing of extracting the TS packets 110 from the respective IP packets structured in the communication format 220 and arranging the extracted TS packets 110. The processing of arranging them includes a processing of lining up the TS packets 110 contained in the respective IP packets into a broadcasting format 210 shown in FIG. 3(d), using the identification information of the TS packets contained in the communication format 220. The processing may also include a processing for error correction such as FEC (Forward Error Correction). The broadcasting format 210 after the conversion contains a plurality of TS packets 110 and is the same format as the broadcasting format 210 shown in FIG. 3(b).

The content processing unit 1030 processes broadcast contents received by the broadcast wave receiver 1010 or communication contents received by the WLAN communication unit 1020. Specifically, the content processing unit 1030 processes the TS packets outputted from the broadcast wave receiver 1010 and the IP packet processing unit 1210. Out of the processed contents, the video portions are sent to the display unit 1050, and the audio portions to the audio output unit 1040. The audio output unit 1040 outputs the audio portions of the contents processed by the content processing unit 1030.

The display unit 1050 displays the video portions of the contents processed by the content processing unit 1030. The display unit 1050 displays a content list generated by the content list generating unit 1120. The display unit 1050 displays images outputted from an H.264 decoder 92 on a display screen.

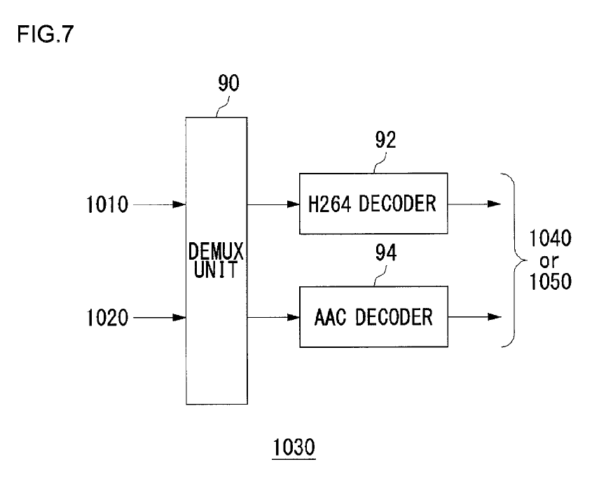

FIG. 7 is a diagram showing an exemplary structure of the content processing unit 1030 of FIG. 5. The content processing unit 1030 includes a Demux unit 90, an H264 decoder 92, and an AAC (Advanced Audio Coding) decoder 94.

The Demux unit 90 produces an output to the H264 decoder 92 or the AAC decoder 94 based on the PID (Packet ID) contained in a TS packet. Specifically, the Demux unit 90 sorts TS packets outputted from the broadcast wave receiver 1010 or the format converting unit 48 by using packets containing control information called SI/PSI (Service Information/Program Specific Information) and produces outputs to the corresponding decoders. Here, if a TS packet contains video data, the Demux unit 90 will output the TS packet to the H264 decoder 92. And if a TS packet contains audio data, the Demux unit 90 will output the TS packet to the AAC decoder 94.

At the H264 decoder 92, the headers of video-related TS packets are removed, and payloads are coupled together to generate a PES (Packetized Elementary Stream) packet. Also, at the H264 decoder 92, the headers of PES packets are removed, and payloads are coupled together to generate an ES (Elementary Stream) packet. Further, the H264 decoder 92 decodes the generated ES and outputs the uncompressed video signals to an output unit 36.

The AAC decoder 94 executes an operation similar to that of the H264 decoder 92 on TS packets containing audio data and outputs the decoded audio data to the output unit 36.

The above-described structures may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

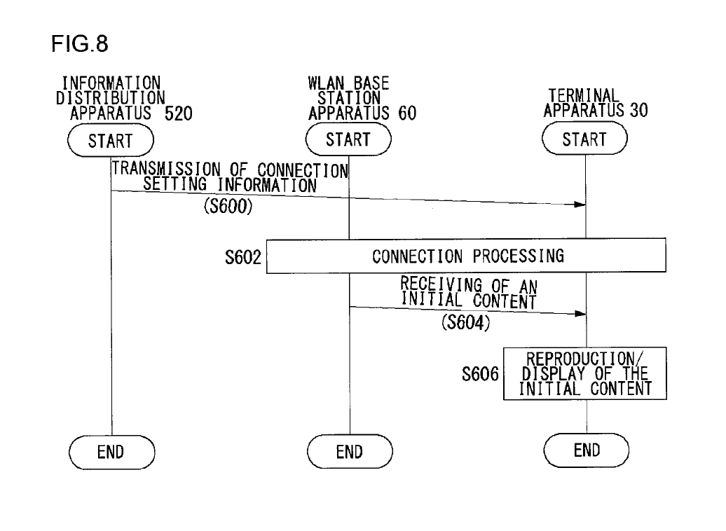

FIG. 8 is a sequence diagram showing an example of connection processing of the communication system 100 of FIG. 1. First the information distribution apparatus 520 transmits connection setting information and the like with which to connect to the WLAN base station apparatus 60, to the terminal apparatus 30 (S600). The terminal apparatus 30 performs a connection processing to connect to the WLAN base station apparatus 60, using the connection setting information received from the information distribution apparatus 520 (S602). Upon completion of the connection, the terminal apparatus 30 receives an initial content from the WLAN base station apparatus 60 (S604), and reproduces and displays it (S606).

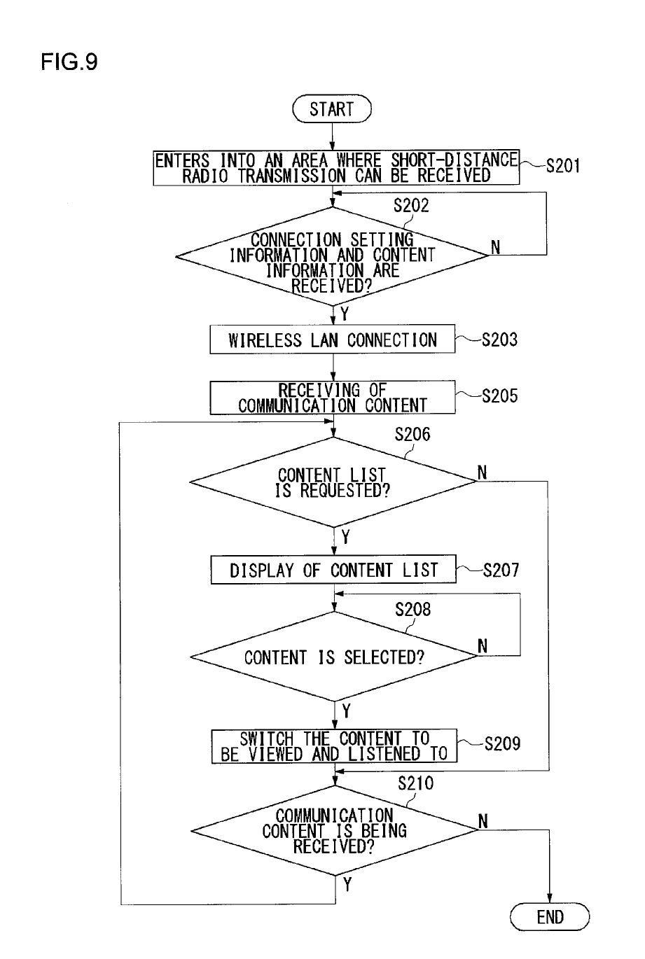

FIG. 9 is a flowchart showing an exemplary operation of the terminal apparatus 30 of FIG. 1. After entry into an area where a short-distance radio transmission can be received (S201), the terminal apparatus 30 waits for a receiving of connection setting information and content information transmitted from the information distribution apparatus 520 (N of S202). When it receives connection setting information and content information (Y of S202), the terminal apparatus 30 establishes a connection to the WLAN base station apparatus 60 based on the received connection setting information (S203).

In the processing of S203, the terminal apparatus 30 first attempts at receiving a beacon of the wireless LAN. If the beacon cannot be received, the terminal apparatus 30 waits until it enters a next short-distance wireless receiving area. If the beacon is received, the terminal apparatus 30 compares the ESSID information contained in the beacon against the ESSID of the connection setting information. With an agreement between those ESSIDs, the terminal apparatus 30 establishes the connection to the wireless LAN. Without an agreement therebetween, the terminal apparatus 30 waits until it enters a next short-distance wireless receiving area.

Then, based on the received content information, the terminal apparatus 30 sets the WLAN communication unit 1020 in order to receive the communication content set in the initial content and receives the communication content distributed from the WLAN base station apparatus 60 (S205).

After that, the terminal apparatus 30 determines whether the user has requested a display of a content list to view and listen to another content (S206). If the user has not requested it (N of S206), the terminal apparatus 30 moves the processing to S210. If the user has requested it (Y of S206), the terminal apparatus 30 causes the display unit 1050 to display the content list (S207) and then waits for the user to select a content (N of S208). And when the content is selected by the user (Y of S208), the terminal apparatus 30 changes the setting of the WLAN communication unit 1020 and switches the content to be viewed and listened to so that the user can view and listen to the selected content (S209). After that, when the signals of the WLAN can no longer be received, for example, when the user has exited the store (N of S210), the terminal apparatus 30 finishes the processing. When the signals of the WLAN can still be received (Y of S210), the terminal apparatus 30 continues the processing from S206.

In the embodiment as described above, the distribution side distributes, through a communication system different from a broadcasting system, data containing contents in a format prescribed for broadcasting that can be reproduced by a terminal apparatus on the reproduction side. Also, the terminal apparatus on the reproduction side extracts data in the format prescribed for broadcasting from the received data and reproduces the extracted data. As a result, the terminal apparatus can acquire the contents easily.

By acquiring connection information with which to connect to the WLAN base station apparatus 60 from a radio apparatus different from the WLAN base station apparatus 60, the terminal apparatus 30 can acquire connection information easily and can perform the connection processing easily.

In the examples of conversion processing shown in FIG. 3, the description has been given to the effect that RTP header information and UDP header information are added to each of the TS packets. However, this should not be considered as limiting and, for example, header information may be added to a plurality of TS packets as a unit. Also, the TS packets may be carried by the communication format 220 without regard to the length or division of the respective TS packets. Moreover, in addition to these, information for error correction, information for timing adjustment, and information necessary for lining up packets may be included. Even in such cases, it can be understood by those skilled in the art that the conversion processings at the terminal apparatus 30 can provide the same effects as those already described by carrying out conversion processings correspondingly reverse to the above-mentioned conversion processings.

Also, in the present embodiment, content information is acquired from the information distribution apparatus; however, the arrangement may be such that content information is acquired from the WLAN base station after the establishment of connection thereto.

Also, in case where there is no WLAN base station apparatus 60 that can be accessed when a communication content is requested from the terminal apparatus 30, it may be so arranged that an access by another communication means is attempted by determining whether the access by another communication means is possible or not based on information on the bit rate for the communication content. The “another communication means” may be a wireless communication means for cellular communication. As another criterion in doing so, a determination may further be made as to whether the user desires another communication means or not. Also, a plurality of destinations of transition of contents may be prepared together with information on the bit rate so that the best image quality may be selected from among them or the one with the least amount of communication may be selected from the viewpoint of communication cost.

(First Modification)

Now a description will be given of a first modification. Note that the components identical to those in the foregoing embodiment are given the identical reference numerals, and the descriptions thereof are simplified. Firstly, an outline explanation is given. The first modification relates to a first distribution system. The first distribution system includes a terminal apparatus, a content distribution apparatus, and a plurality of APs. The first distribution system is suited for application in relatively large-scale retail stores such as shopping centers.

As in the above-described embodiment, a content list covering plural pieces of advertising information and the like may be received, and the user may select a content to be viewed and listened to from the content list received. However, when there are many contents, the work of selecting may sometimes be troublesome. With the first distribution system, therefore, the arrangement is such that the contents to be received switch automatically from one kind to another according to the area where the terminal apparatus is located.

As will be described in detail later, the first distribution system has a plurality of APs installed in each of the stores of a shopping center or in each of the areas within a store. An AP carries part of a function of distributing contents. The AP relays communications between the terminal apparatus and the content distribution apparatus. The terminal apparatus connects to one of the plurality of APs. The terminal apparatus acquires area information from the AP to which it is connected and recognizes the place within the store where it is located. Based on the area information, the terminal apparatus determines an optimum content (hereinafter referred to as “area content”) in the area indicated by the area information.

The area content may change from one kind to another, depending on the AP in connection. Note that the area content may have to do with, for instance, advertisement of the stores or merchandise near the location of the AP. According to this modification, the content provider can enhance the effect of advertisement by distributing advertising information and the like in a limited area. The users, too, can obtain information useful on the spot without bearing communication cost. Note that the following description makes no distinction between the area content and the content.

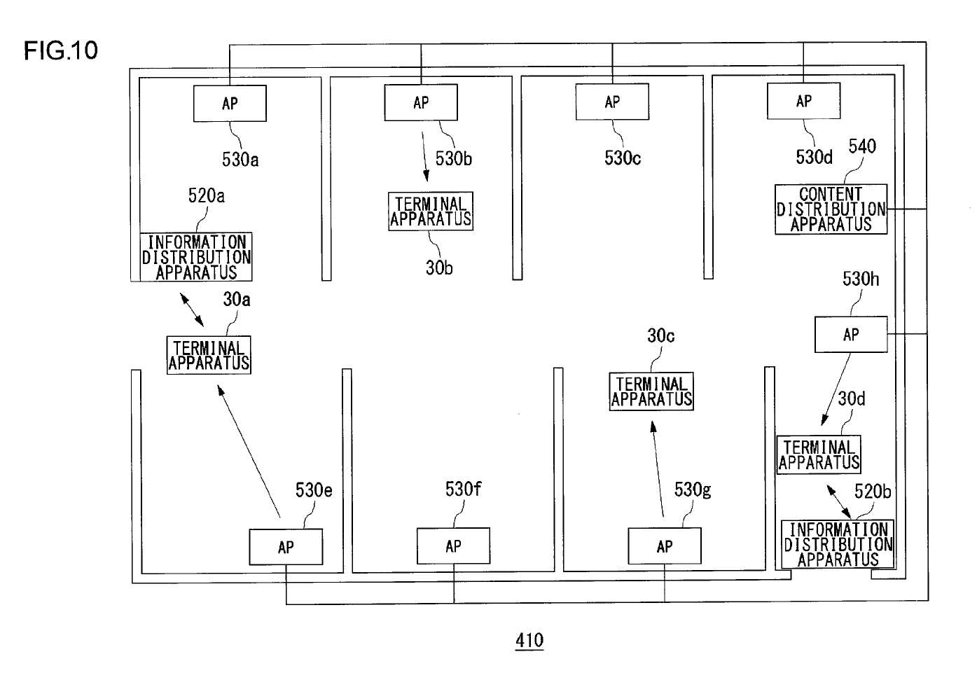

FIG. 10 is a diagram showing an exemplary structure of a first distribution system 410 according to the first modification. The first distribution system 410 includes a first terminal apparatus 30a, a second terminal apparatus 30b, a third terminal apparatus 30c, and a fourth terminal apparatus 30d, which are represented by “terminal apparatus 30”, a first AP 530a through an eighth AP 530h, which are represented by “AP 530”, a first information distribution apparatus 520a and a second information distribution apparatus 520b, which are represented by “information distribution apparatus 520”, and a content distribution apparatus 540. Note that the information distribution apparatus 520 is of the same structure as that of the information distribution apparatus 520 shown in FIG. 4 and the description thereof is omitted. As illustrated in FIG. 10, a plurality of APs 530, a plurality of information distribution apparatus 520, and a content distribution apparatus 540 are installed within a store 600. It is to be noted that the numbers of terminal apparatuses 30 and APs 530 are not limited to those shown in FIG. 10. Also, the information distribution apparatuses 520 may be installed outside the store 600 near the entrance thereto.

In the first distribution system 410, areas where short-distance radio signals can be received are created near a plurality of entry and exit points of the store by the information distribution apparatuses 520. Also, areas where WLAN communications are available are created near the location of the APs 530 or the content distribution apparatus 540. An information distribution apparatus 520 transmits connection setting information and content information to terminal apparatuses 30 within the area where the short-distance radio signals can be received. An AP 530 stores AP information which includes its own identification information associated with the area content.

The AP information includes identification information indicating an AP 530 and information for acquisition of area content distributed by the AP 530. In other words, the content distribution apparatus 540 and the first AP 530a through the eighth AP 530h have AP information including mutually different identification information. The terminal apparatus 30 receives AP information from the AP 530 to which it is connected. The terminal apparatus 30 acquires an area content based on the IP address and the port No. contained in the received AP information. In this mode of application, the terminal apparatus 30 can easily switch area contents to be acquired according to the location of the AP 530 which is installed on the periphery of it.

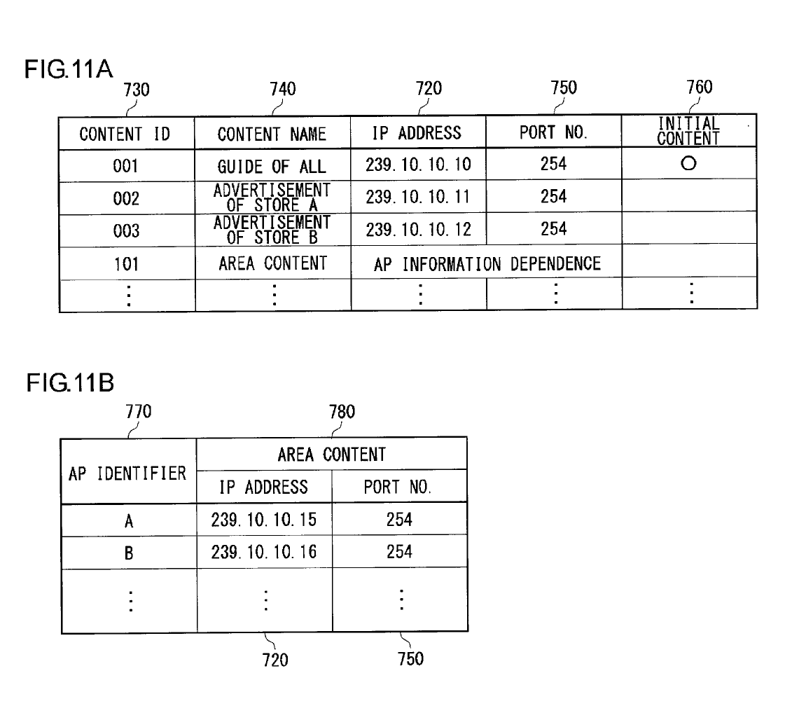

FIGS. 11(a) and 11(b) are diagrams showing examples of content information and AP information, respectively, according to the first modification.

FIG. 11(a) is an example of content information. Since FIG. 11(a) is similar to FIG. 6(b), the description thereof will be simplified. Included is “AP information dependence” in the IP address column 720 and the port No. column 750 corresponding to “101” of the content IDs shown in the content ID column 730. The “AP information dependence” means that they are set according to the AP information to be described later.

FIG. 11(b) is an example of AP information. For convenience of explanation, plural pieces of AP information are shown here, but, as described previously, the AP 530 holds only one piece of AP information indicating itself. The AP information includes an AP identifier shown in an AP identifier column 770 and an IP address and port No. for the receiving of an area content shown in an area content column 780. The AP identifier is an identifier for identifying the AP 530. The IP address column and the port No. column in the area content column show multicast addresses and port Nos. respectively for the receiving of area contents.

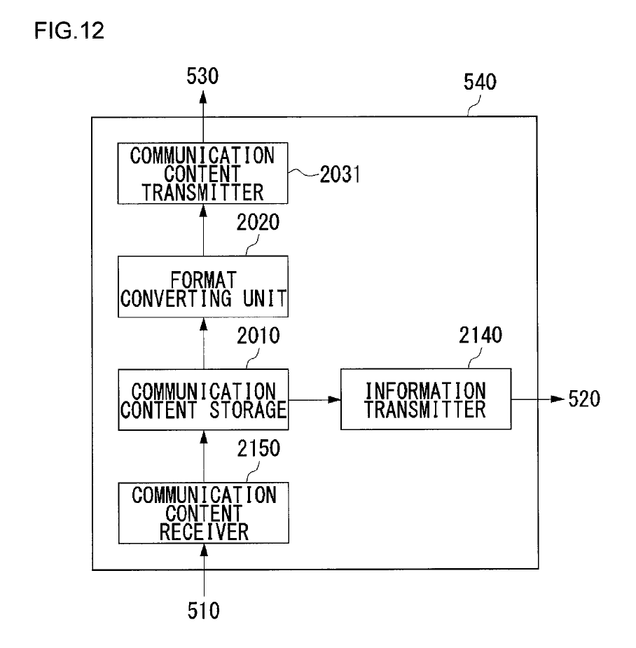

FIG. 12 is a diagram showing an exemplary structure of the content distribution apparatus 540 of FIG. 10. The content distribution apparatus 540 is of the same structure as that of the content distribution apparatus 540 including the communication content transmitter 2031 in the WLAN base station apparatus 60 shown in FIG. 2.

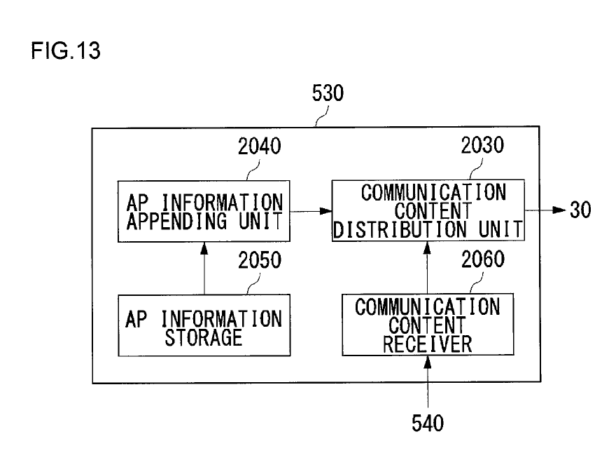

FIG. 13 is a diagram showing an exemplary structure of an AP 530 of FIG. 10. The AP 530 includes a communication content distributing unit 2030, an AP information appending unit 2040, an AP information storage 2050, and a communication content receiver 2060. The AP information storage 2050 retains AP information including an AP identifier indicating its own AP 530. The AP information thus retained is referenced by the AP information appending unit 2040. The AP information appending unit 2040 sends the AP information stored in the AP information storage 2050 to the communication content distributing unit 2030.

The communication content receiver 2060 receives communication contents distributed from the content distribution apparatus 540 and transfers them to the communication content distributing unit 2030. The communication content distributing unit 2030 appends the AP information transmitted from the AP information appending unit 2040 to the communication content transferred from the communication content receiver 2060. Although it is intended herein that the communication content is transmitted by multicast, it can be transmitted and received by unicast. In such a case, the AP information is added by a method in which a unicast transmission is made only immediately after IP connection. However, it is also possible to use a method in which the AP information is transmitted by multicast at regular intervals.

Referring back to FIG. 10, the terminal apparatus 30 is of the same structure as that of the terminal apparatus 30 shown in FIG. 5, so that the description thereof will be simplified. The terminal apparatus 30 receives AP information from the AP 530. The terminal apparatus 30 acquires an area content based on the received AP information.

An explanation will be given in concrete terms. Here, it is assumed that the terminal apparatus 30 is connected to the AP 530 whose AP identifier shown in the AP identifier column 770 in FIG. 11(b) is “A”. In this case, if the user desires to acquire an area content, for example, the content ID “101” shown in the content ID column 730 of FIG. 11(a), then the terminal apparatus 30 will receive the AP information with the AP identifier set to “A” from the AP 530 to which the terminal apparatus 30 is connected.

The terminal apparatus 30 carries out a setting for the WLAN communication unit 1020 based on the acquired IP address and the like. According to this modification, the terminal apparatus 30 can acquire an area content corresponding to the AP identifier “A”.

By implementing this modification, when the user moves from one point to another, the terminal apparatus 30 can automatically switch to the content of the point of arrival. When the user moves while viewing and listing to the area content, the access point for the terminal apparatus 30 switches to an AP 530 installed near the user's point of arrival. The display on the terminal apparatus 30 switches to the area content appropriate for the location where the newly accessed AP 530 is installed.

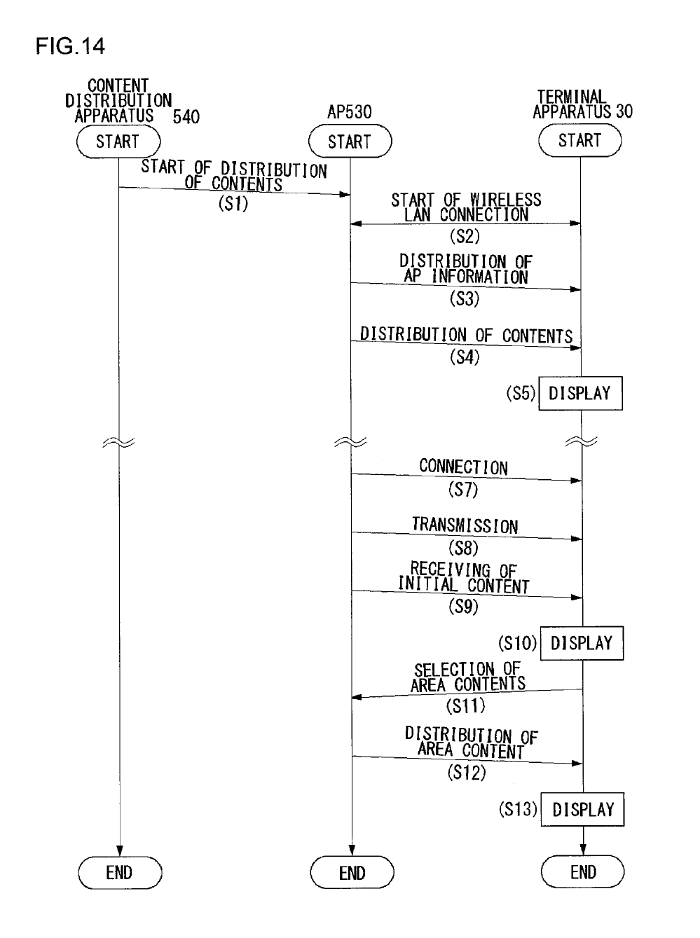

FIG. 14 is a sequence diagram showing an exemplary operation of the first distribution system 410 of FIG. 10. First the content distribution apparatus 540 starts distributing all the contents including an area content to all the APs 530 by multicast (S1). When the terminal apparatus 30 has moved closer to the first AP 530a, the terminal apparatus 30 establishes a wireless LAN connection to the first AP 530a (S2). Then the terminal apparatus 30 transmits an AP information distribution request including its own IP address to the first AP 530a, and in response the first AP 530a transmits AP information to the terminal apparatus 30 by unicast (S3). The terminal apparatus 30 participates in a multicast group using IGMP (Internet Group Management Protocol) and thereby starts receiving an initial content (S4) and decodes it for a display thereof (S5).

Now as the terminal apparatus 30 moves away from the first AP 530a and closer to the second AP 530b, the terminal apparatus 30 severs the connection with the first AP 530a and establishes a connection to the second AP 530b (S7). The terminal apparatus 30 participates in a multicast group using IGMP (S8) and thereby starts receiving an initial content (S9) and decodes it for a display thereof (S10). Here, if the user desires to view and listen to the area content, the terminal apparatus 30, following the acquired AP information, executes a processing to select another multicast group (S11), receives the area content (S12), and displays it (S13). Note that the processings of S2 to S5 correspond to those of S7 to S10.

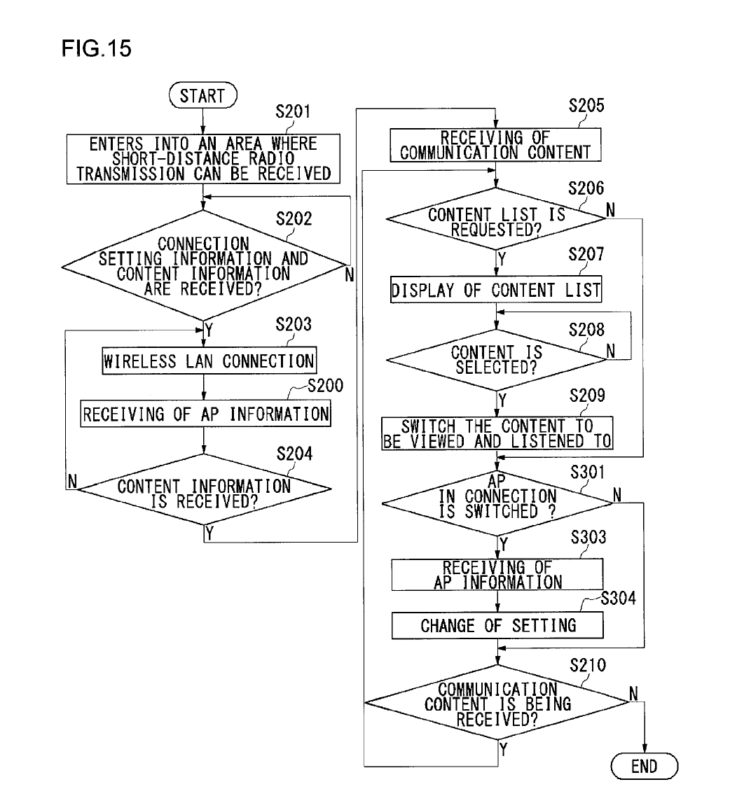

FIG. 15 is a flowchart showing an exemplary operation of the terminal apparatus 30 of FIG. 10. The flowchart shown in FIG. 15 includes, in addition to the processings of the flowchart shown in FIG. 9, the processings of S200 and S204, to be described later, after the processing of S203 and the processings of S301 to S304, to be described later, between the processings of S209 and S210. After the processing of S203, the terminal apparatus 30 receives AP information from the AP 530 in connection therewith by unicast (S200). Then the terminal apparatus 30 waits for a receiving of content information (S204). Where there is no receiving of content information (N of S204), the processing returns to S203. With the receiving of content information (Y of S204), the processing moves to S205.

After the processing of S209, the terminal apparatus 30 determines whether the AP 530 in connection therewith has switched or not (S301). If it has not switched (N of S301), the processing moves to S210. If it has switched (Y of S301), the terminal apparatus 30 receives AP information (S303). The terminal apparatus 30 stores the AP information therewithin and changes the setting (S304). The stored AP information is used for the receiving of area content and the like. Then the processing moves to S210.

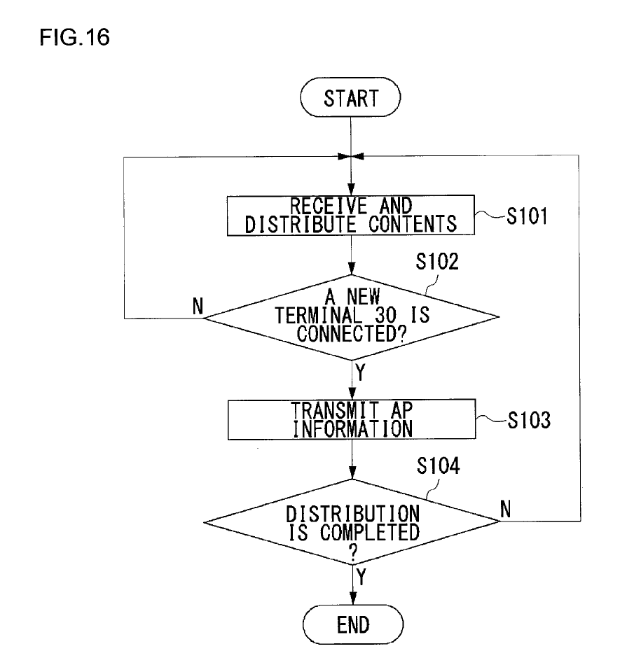

FIG. 16 is a flowchart showing an exemplary operation of the AP 530 of FIG. 10. The AP 530 receives contents transferred from the content distribution apparatus 540 and distributes the received contents by multicast (S101). Thereafter, the distribution is performed continuously. Then the AP 530 waits for a new connection by the terminal apparatus 30 (S102). With a new connection (Y of S102), the AP 530 transmits AP information to the connected terminal apparatus 30 by unicast (S103) and moves to the processing of S104. Without a new connection (N of S102), the AP 530 returns to the processing of S101. If the distribution is completed in S104 (Y of S104), the AP 530 finishes the processing. If the distribution is not completed (N of S104), the AP 530 returns to the processing of S101.

According to this modification, when the user moves from one point to another, the user can easily acquire the area content appropriate for the user's point of arrival. Also, the area content switching automatically according to the location improves convenience for the user.

(Second Modification)

Next, a description will be given of a second modification. Note that the components identical to those in the above-described embodiment or modification are given the identical reference numerals, and the descriptions thereof are simplified. Firstly, an outline explanation is given. The second modification relates to a second distribution system. The second distribution system includes a terminal apparatus, a content distribution apparatus, an AP, and an information distribution apparatus. The second distribution system is suited for application in a facility having a plurality of closed spaces, such as a movie house, or where it is desired that the area within a facility be segmented.

In the second distribution system 420 according to the second modification, the terminal apparatus 30 switches the source of content by receiving AP information from the AP 530 to which it is connected. In the second distribution system according to the second modification, the arrangement is such that an information distribution apparatus to form a short-distance radio network is installed in each area and the terminal apparatus receives information distribution apparatus information, which is equivalent to the above-described AP information, from the information distribution apparatus. According to this modification, the terminal apparatus can switch the communication content to be acquired from the connected AP or content distribution apparatus or information distribution apparatus according to the area. In this case, information distribution apparatuses must be installed, but it is possible to divide the area into more parts than in the first modification.

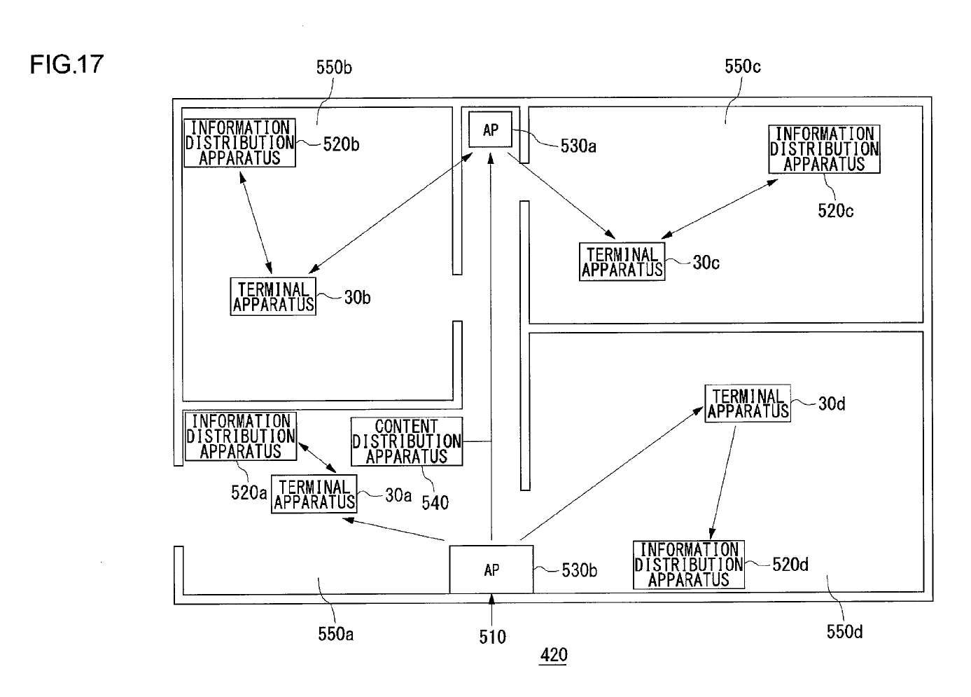

FIG. 17 is a diagram showing an exemplary structure of the second distribution system 420 according to the second modification. The second distribution system 420 includes a first terminal apparatus 30a to a fourth terminal apparatus 30d, which are represented by “terminal apparatus 30”, a first information distribution apparatus 520a to a fourth information distribution apparatus 520d, which are represented by “information distribution apparatus 520”, a first AP 530a, a second AP 530b, and a content distribution apparatus 540. The second distribution system 420 includes a first area 550a to a fourth area 550d, which are represented by “area 550”. An information distribution apparatus 520 is installed in each of the areas 550. A terminal apparatus 30 recognizes the area 550 where it is located, based on the information distribution apparatus information received from the information distribution apparatus 520 through a short-distance radio network.

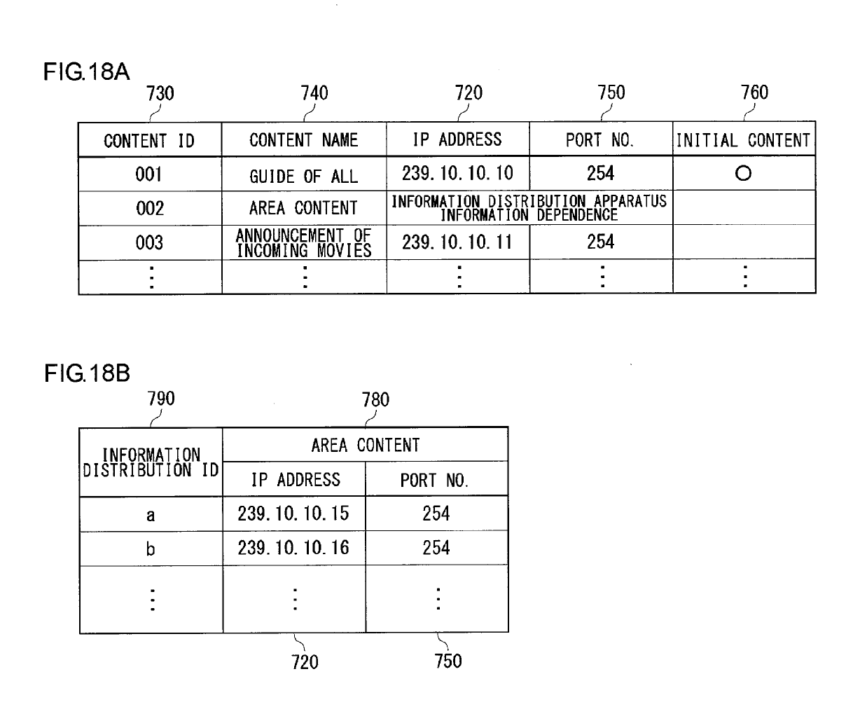

Here, an explanation is given of the information distribution apparatus information and so forth. FIGS. 18(a) and 18(b) are diagrams showing examples of content information and information distribution apparatus information, respectively, according to the second modification.

FIG. 18(a) is an example of content information. Since FIG. 18(a) is similar to FIG. 11(a), the description thereof will be simplified. “Information distribution apparatus information dependence” is set in the IP address column and the port No. column corresponding to “002” of the content IDs shown in the content ID column 730. The “information distribution apparatus information dependence” means that, similar to the “AP information dependence” explained in FIG. 11(a), the IP address and port No. for acquisition of the area content shown by the content ID are set by the information distribution apparatus information of FIG. 18(b) to be described later.

FIG. 18(b) is an example of information distribution apparatus information. For convenience of explanation, plural pieces of information distribution apparatus information are shown here, but, as described previously, the information distribution apparatus 520 holds only one piece of information distribution apparatus information indicating itself. The information distribution apparatus information includes an information distribution apparatus ID shown in an information distribution apparatus ID column 790 and an IP address and port No. of an area content shown in an area content column 780. The information distribution apparatus ID is an identifier for identification of the information distribution apparatus 520. The IP address column and the port No. column in the area content column are the same as those explained in FIG. 11(b), and therefore the description thereof is omitted.

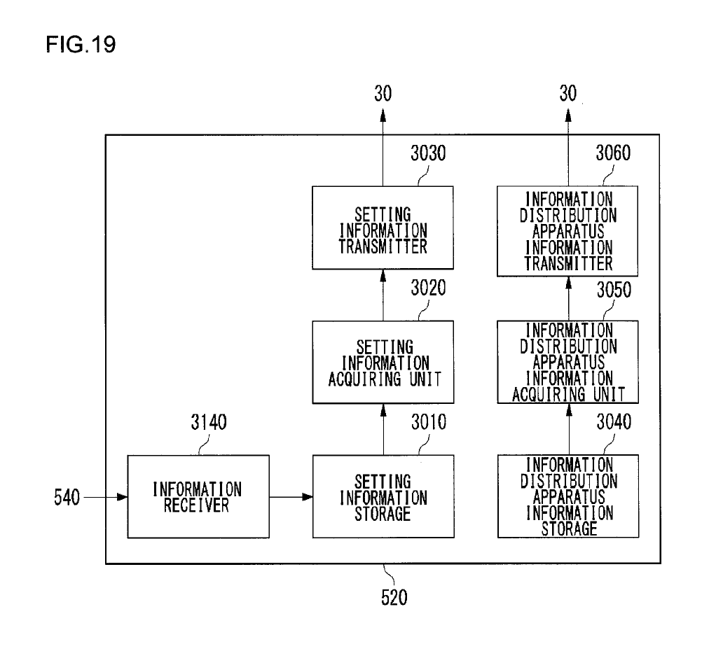

FIG. 19 is a diagram showing an exemplary structure of an information distribution apparatus 520 of FIG. 17. The information distribution apparatus 520 further includes, in addition to the structure of the information distribution apparatus 520 shown in FIG. 4, an information distribution apparatus information storage 3040, an information distribution apparatus information acquiring unit 3050, and an information distribution apparatus information transmitter 3060.

The information distribution apparatus information storage 3040 stores information distribution apparatus information on the information distribution apparatus 520. The information distribution apparatus information being stored varies with each area 550 where the information distribution apparatus 520 is installed. The information distribution apparatus information being stored by the information distribution apparatus information storage 3040 is referenced by the information distribution apparatus information acquiring unit 3050. The information distribution apparatus information acquiring unit 3050 acquires information distribution apparatus information stored in the information distribution apparatus information storage 3040. The information distribution apparatus information acquiring unit 3050 sends the acquired information distribution apparatus information to the information distribution apparatus information transmitting unit 3060. The information distribution apparatus information transmitter 3060 determines whether the terminal apparatus 30 is connected to the information distribution apparatus 520 or not. Also, the information distribution apparatus information transmitter 3060 transmits the information distribution apparatus information sent from the information distribution apparatus information acquiring unit 3050 through a short-distance radio communication network to the terminal apparatus 30 which is connected thereto.

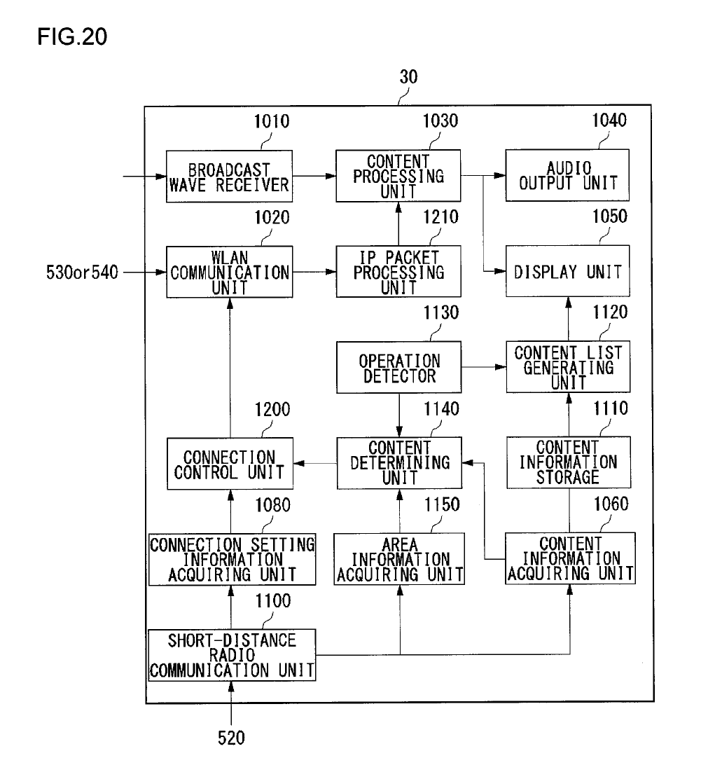

FIG. 20 is a diagram showing an exemplary structure of a terminal apparatus 30 of FIG. 17. The terminal apparatus 30 shown in FIG. 20 further includes an area information acquiring unit 1150 in addition to the structure of the terminal apparatus 30 shown in FIG. 5. The area information acquiring unit 1150 acquires area information based on the information distribution apparatus information received by the short-distance radio communication unit 1100. The area information, which indicates an information distribution apparatus ID contained in information distribution apparatus information, is information showing the area where the terminal apparatus 30 is located. The area information acquiring unit 1150 transmits the acquired area information to the content determining unit 1140. The content determining unit 1140 switches the area content to be displayed on the display unit 1050, using the transmitted area information.

Referring back to FIG. 17, the content distribution apparatus 540 includes a communication content receiver, a communication content storage, a communication content acquiring unit, and a communication content transmitter. The communication content receiver, the communication content storage, the communication content acquiring unit, and the communication content transmitter are the same as the communication content receiver 2150, the communication content storage 2010, the format converting unit 2020, and the communication content transmitter 2031, respectively, of the content distribution apparatus 540 shown in FIG. 12. Thus the description thereof is omitted.

The AP 530 includes a communication content receiver and a communication content distributing unit. The communication content distributing unit and the communication content receiver are the same as the communication content distributing unit 2030 and the communication content receiver 2060, respectively, of the AP 530 shown in FIG. 13, and therefore the description thereof is omitted.

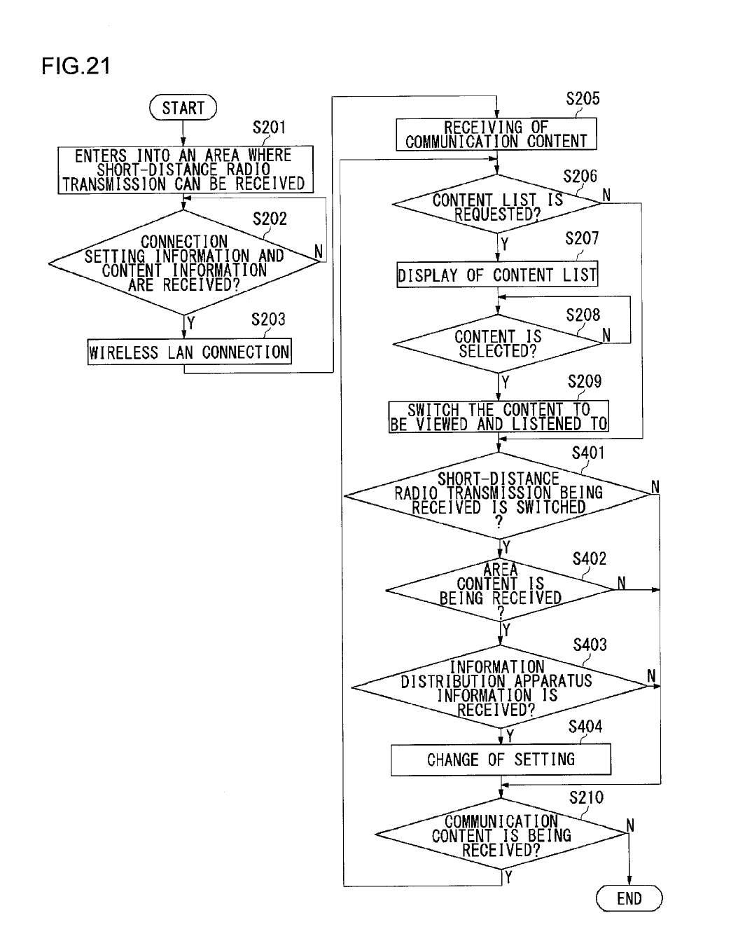

FIG. 21 is a flowchart showing an exemplary operation of the terminal apparatus 30 of FIG. 17. The flowchart shown in FIG. 21 includes the processings of S401 to S404 in place of the processings of S301 to S304 in the flowchart shown in FIG. 15. Also, the flowchart shown in FIG. 21 leaves out the processings of S200 and S204 of FIG. 1, and that is because in the present modification, the connection information distribution apparatus information is not received in advance as in the first modification, and the area content is received only during the receiving. It may also be arranged that this one too is received in advance.

After the processing of S209, the terminal apparatus 30 determines whether the information distribution apparatus 520 that can receive has switched or not (S401). If it has not switched (N of S401), the processing moves to S210. If it has switched (Y of S401), the terminal apparatus 30 determines whether the area content is being received or not (S402). If the area content is not being received (N of S402), the processing moves to S210. If the area content is being received (Y of S402), the terminal apparatus 30 waits for a receiving of information distribution apparatus information (S403). When the information distribution apparatus information is received (Y of S403), the terminal apparatus 30 changes the setting of the WLAN communication unit 1020 based on the received information distribution apparatus information (S404). After that, the processing moves to S210. When the information distribution apparatus information is not received (N of S403), the processing moves to S210.

According to this modification as described above, an information distribution apparatus 520 to form a short-distance radio network is installed in each area, and the terminal apparatus 30 receives information distribution apparatus information, which is equivalent to AP information, also from the information distribution apparatus 520. As a result, the communication content to be acquired can be switched easily, and the area within a store can be divided into more parts thereof.

(Third Modification)

Next, a description will be given of a third modification. Note that the components identical to those in the above-described embodiment or modifications are given the identical reference numerals, and the descriptions thereof are simplified. Firstly, an outline explanation is given. The third modification relates to a third distribution system. The third distribution system includes a terminal apparatus, a content distribution apparatus, an AP, and an information distribution apparatus. The third distribution system is suited for application in a facility having a plurality of closed spaces, such as a movie house, or where it is desired that the area within a facility be segmented.

The difference from the second distribution system is that the content information is transmitted from the AP instead of from the information distribution apparatus. With this structure, the cost per information distribution apparatus can be reduced. As a result, the increased number of information distribution apparatuses can be installed in a facility where the third distribution system is installed and therefore the area can be segmentalized.

Similar to the second distribution system 420 as shown in FIG. 17, the third distribution system (not shown) includes a terminal apparatus 30, an information distribution apparatus 520, an AP 530, and a content distribution apparatus 540. The terminal apparatus 30 acquires connection setting information and information distribution apparatus information from the information distribution apparatus 520 through a short-distance radio communication network. However, no information on area contents is contained in the information distribution apparatus information received. The terminal apparatus 30 acquires the information on area contents, from the AP 530.

The content information includes a content (area content) prescribed for each of information distribution apparatus IDs, and a content commonly prescribed for all information distribution apparatuses. If, for instance, the third distribution system is installed in a movie house, the content commonly prescribed for all information distribution apparatuses will include a content as to what are business days of the movie house. Such a content does not switch even though a user moves and therefore it can be viewed and listened to in any area.

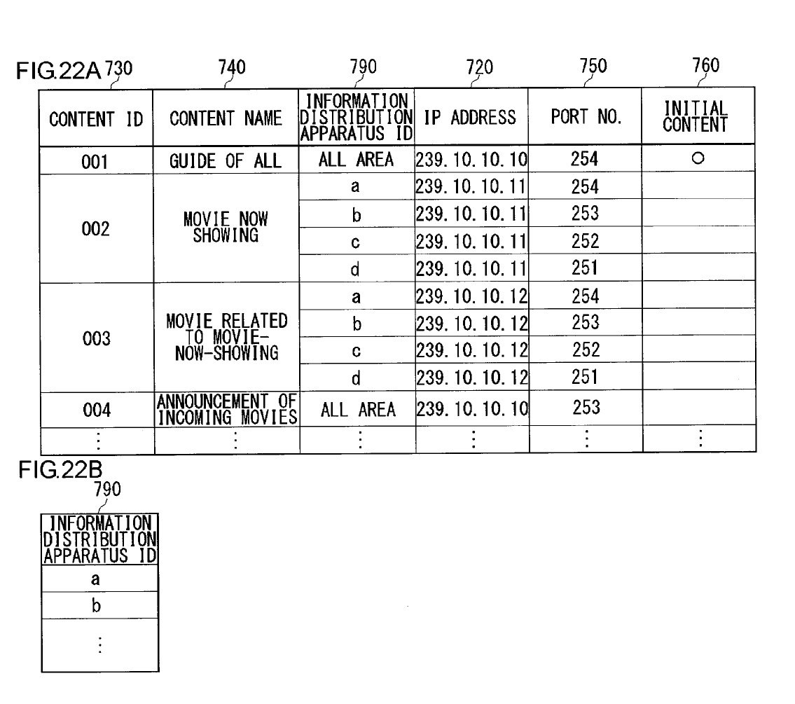

FIGS. 22(a) and 22(b) are diagrams showing examples of content information and information distribution apparatus information in the third modification. FIG. 22(a) shows an example of content information. The content information contains information shown in FIG. 18(a) and information distribution apparatus IDs shown in an information distribution apparatus ID column 790. The content IDs “001” and “004” are contents prescribed commonly for all information distribution apparatuses. The content IDs “002” and “003” are those set for each information distribution apparatus ID, as described above. Other than these points, the content information is similar to that of FIG. 18(a). FIG. 22(b) is information distribution apparatus information indicated in the information distribution apparatus ID column 790. As described above, the information distribution apparatus information does not contain information on the area content but contains the information distribution apparatus IDs only.

Since the terminal apparatus 30 has a similar structure to that shown in FIG. 20, the description thereof is omitted. The information distribution apparatus 520 differs from the information distribution apparatus 520 shown in FIG. 19 in the feature that the setting information storage 3010 stores connection setting information only and does not store the content information. Since the structure and feature are the same except for this difference that the content information is not stored, the description thereof is omitted.

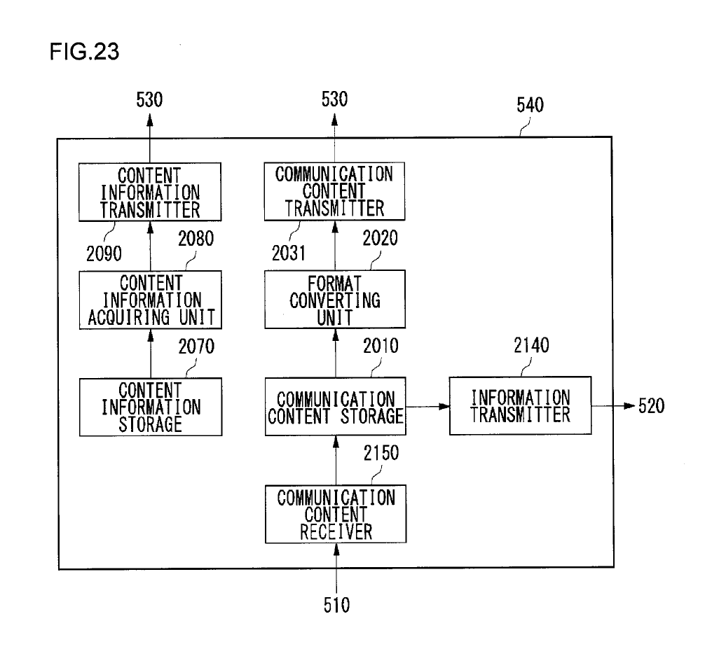

FIG. 23 is a diagram showing an exemplary structure of a content distribution apparatus 540 according to the third modification. The content distribution apparatus 540 includes a communication content receiver 2150, a communication content storage 2010, a format converting unit 2020, a communication content transmitter 2031, a content information storage 2070, a content information acquiring unit 2080, and a content information transmitter 2090. The structures of the communication content receiver 2150, the communication content storage 2010, the format converting unit 2020 and the communication content transmitter 2031 are similar to those described in FIG. 12 and therefore the description thereof is omitted.

The content information storage 207 retains content information. The content information retained thereby is referenced by the content information acquiring unit 2080. The content information acquiring unit 2080 acquires the content information retained in the content information storage 2070, and transmits it to the content information transmitter 2090. If the terminal apparatus 30 is connected to the AP 530, the content information transmitter 2090 will transmit the content information received from the content information acquiring unit 2080, to the AP 530.

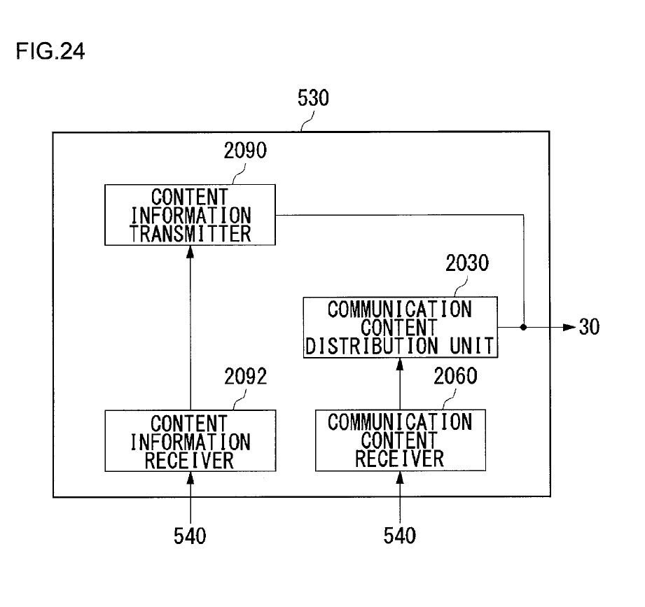

FIG. 24 is a diagram showing an exemplary structure of the AP 530 according to the third modification. The AP 530 includes a communication content distribution unit 2030, a communication content receiver 2060, a content information transmitter 2090, and a content information receiver 2092. The structures of the communication content distribution unit 2030 and the communication content receiver 2060 are similar to those described in FIG. 13 and therefore the description thereof is omitted.

The content information receiver 2130 receives the content information transmitted from the content distribution apparatus 540. The content information transmitter 2090 transmits the content information received by the content information receiver 2092, to the terminal apparatus 30 which is in connection with the content information transmitter 2090.

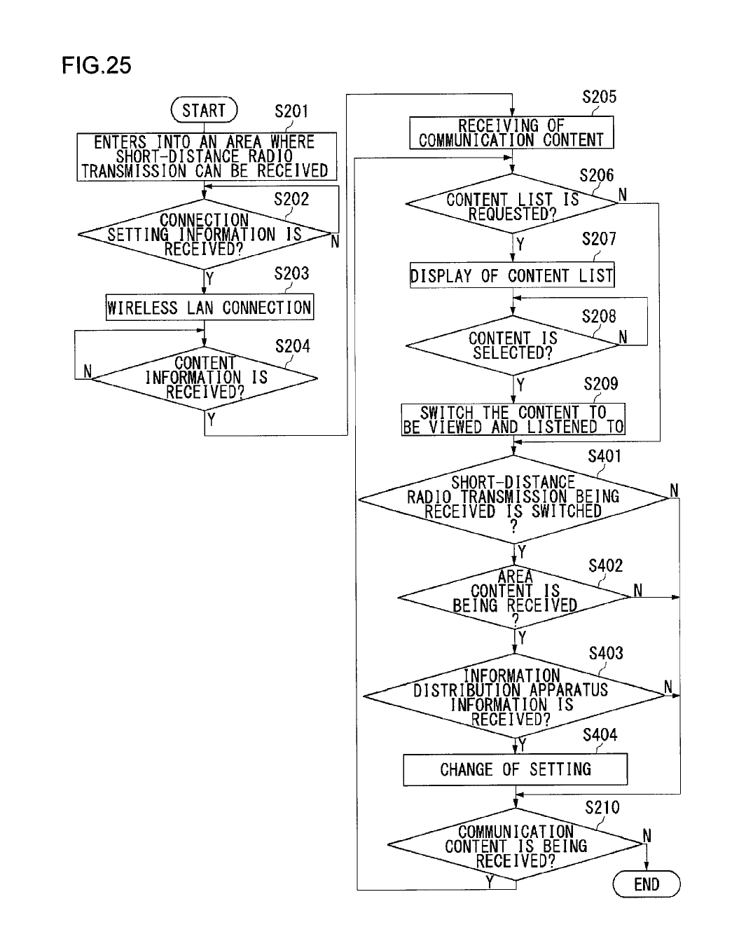

FIG. 25 is a flowchart showing an exemplary operation of the terminal apparatus 30 according to the third modification. This flowchart is the same as the flowchart shown in FIG. 21 except for the following processings S202 to S205. In S202, the terminal apparatus 30 receives connection setting information from the information distribution apparatus 520 (S202). Here, if the connection setting information is received (Y of S202), the terminal apparatus 30 will establish a WLAN connection (S203) and wait for a receiving of content information from the AP 530 (S204). If the content information is received from the AP 530 (Y of S204), the terminal apparatus 30 will receive communication contents based on the received content information (S205).

According to this modification, transmitting the content information from the AP 530 in place of from the information distribution apparatus 520 enables a reduction in cost per information distribution apparatus. As a result, the increased number of information distribution apparatuses can be installed in the facility where the third distribution system is installed and therefore the area can be segmentalized.

(Fourth Modification)

Next, a description will be given of a fourth modification. Note that the components identical to those in the above-described embodiment or modifications are given the identical reference numerals, and the descriptions thereof are simplified. Firstly, an outline explanation is given. The fourth modification relates to a fourth distribution system. The fourth distribution system includes a terminal apparatus, a content distribution apparatus, an AP, and an information distribution apparatus. The information distribution apparatus includes a normal information distribution apparatus and a privileged information distribution apparatus. The fourth distribution system differs from the third distribution system in the feature that the fourth distribution system includes the privileged information distribution apparatus. The normal information apparatus and the privileged information distribution apparatus will be discussed later.

The fourth distribution system is suitable for a facility having a relatively large-scale area such as an amusement park with a plurality of play facilities, a zoo, an event site that holds events, or the like.

The contents distributed in an amusement park are menus of restaurants, how crowded a play facility is, products sold in retail stores, event information in a facility, or the like. The contents concerning how crowded a play facility or the like are generated from images captured by a video camera or the like placed on the perimeter. The contents include privileged contents. The privileged contents are contents which can be viewed and listened to only when a specific condition is met. The specific condition includes a case where the user moves to a specific location or encounters a specific person. Note here that since the contents are distributed using multicast, they can be intercepted by accident or intentionally. Thus, if they are privileged contents, it is desirable to prevent them from being intercepted.

In the light of this, in the fourth distribution system the communication contents are encrypted and then the encrypted communication contents are distributed and decryption keys used to decode them are appended to the content information. As a result, only the users who have acquired the content information can view and listen to said contents.

It is desirable that contents relating to play facilities, such as preferential use tickets which can be preferentially used on the play facilities, be distributed around the play facilities. Thus, similar to the third distribution system, in the fourth distribution system the area information is appended to the content information so that the content can be viewed and listened to in the surrounding area only.

The fourth distribution system has a similar structure to that of the third distribution system. Note, however, that an information distribution apparatus 520 includes a normal information distribution apparatus 522 and a privileged information distribution apparatus 524. The privileged information distribution apparatus 524 is an information distribution apparatus installed on the perimeter of a specific facility. The privileged information distribution apparatus 524 may be carried by a specific person.

The privileged information distribution apparatus has privileged content information. The privileged content information is content information relating to encrypted privileged contents. The privileged content information includes decryption keys used to decode the encrypted privileged contents.

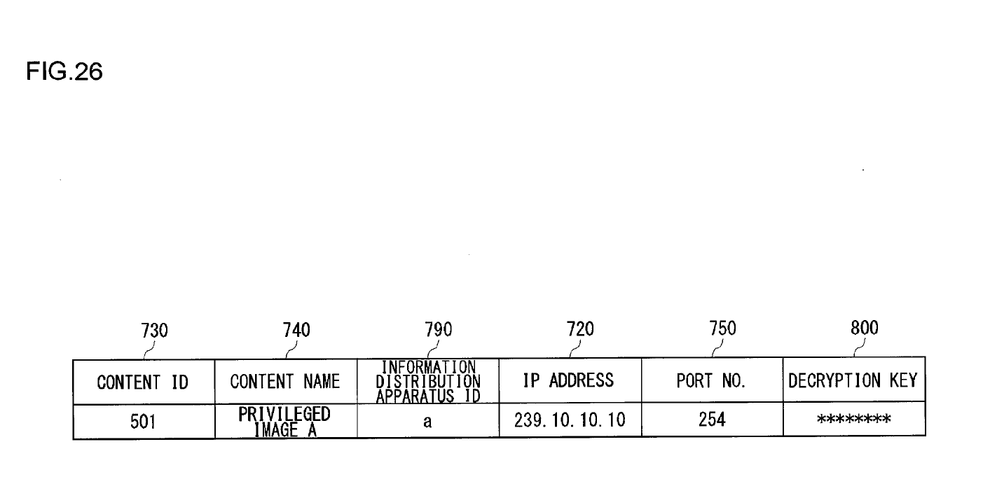

FIG. 26 is a diagram showing an example of privileged content information in the fourth modification. Privileged content information includes a content ID indicated in a content ID column 730, a content name indicated in a content name column 740, an information distribution apparatus ID indicated in an information distribution apparatus ID column 790, an IP address indicated in an IP address column 720, a port No. indicated in a port No. column 750, and a decryption key indicated in a decryption key column 800. The privileged content information is information which can be acquired from the privileged information distribution apparatus 524 only. A terminal apparatus that has acquired this privileged content information can receive a privileged content associated with the acquired privileged content information and can view and listen to it. The information distribution apparatus ID indicates the information distribution apparatus ID of a privileged information distribution apparatus 524 capable of acquiring the privileged content information. The decryption key is a decryption key used to decode the privileged content.

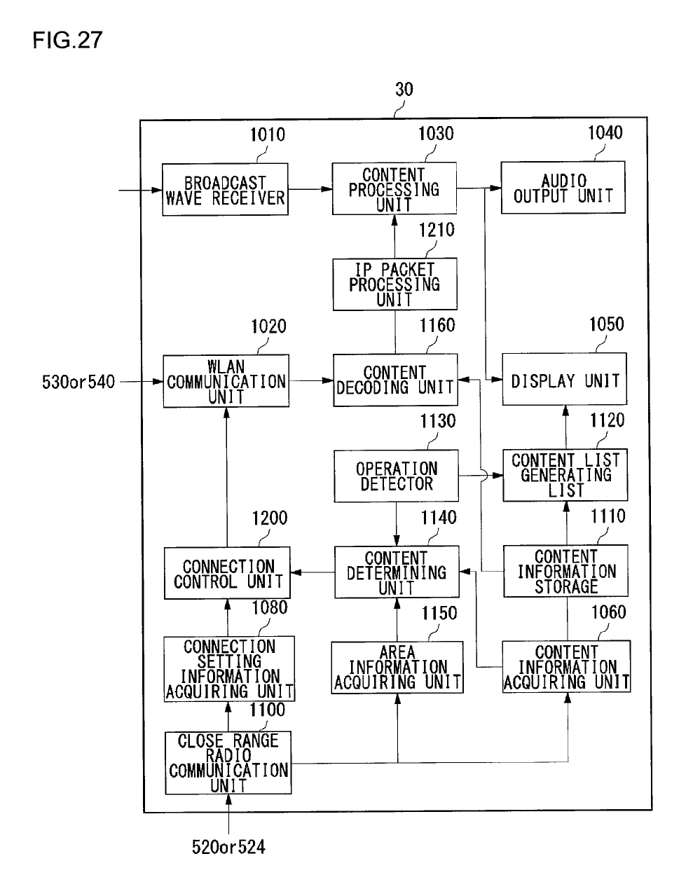

FIG. 27 is a diagram showing an exemplary structure of the terminal apparatus 30 according to the fourth modification. The terminal apparatus 30 further includes a content decoding unit 1160 in addition to the components of the terminal apparatus 30 shown in FIG. 20.

The short-distance radio communication unit 1100 receives privileged content information from the privileged information distribution apparatus 524. The short-distance radio communication unit 1100 transmits the thus acquired privileged content information to the content information acquiring unit 1060. The content information acquiring unit 1060 stores the privileged content information in the content information storage 1110. The privileged content information stored therein contains decryption keys used to decode privileged contents.

The WLAN communication unit 1020 receives encrypted privileged contents from the AP 530 and transmits them to the content decoding unit 1160. The content decoding unit 1160 decodes the privileged contents received by the WLAN communication unit 1020. When the decoding is to be performed, the content information acquiring unit 1060 acquires decryption keys corresponding to the privileged contents stored in the content information storage 1110, and decodes the privileged contents by the use of the decryption keys. The privileged contents that have been decoded are sent to the content processing unit 1030 and processed there sequentially. When the WLAN communication unit 1020 receives a communication content that has not been encrypted, the communication content is sent to the IP packet processing unit 1210 and processed there in the same way as described above. In the fourth modification, the processing is carried out by the content decoding unit 1160 and then the IP packet processing unit 1210 in this order. However, if the processing is carried out by the IP packet processing unit 1210 and then the content decoding unit 1160 in this order, the encryption can be completed within the TS packet only and therefore the processing can be accomplished using a circuit similar to the existing circuit used for the broadcasting encryption.

The AP 530 is of the same structure as that shown in FIG. 13 excepting the AP information appending unit 2040 and the AP information storage 2050 which are not provided here. Since the other structural components are the same as those of the AP 530 shown in FIG. 13, the description thereof is omitted. The structure of the content distribution apparatus 540 is similar to that of the content distribution apparatus 540 shown in FIG. 12 and therefore the description thereof is omitted.

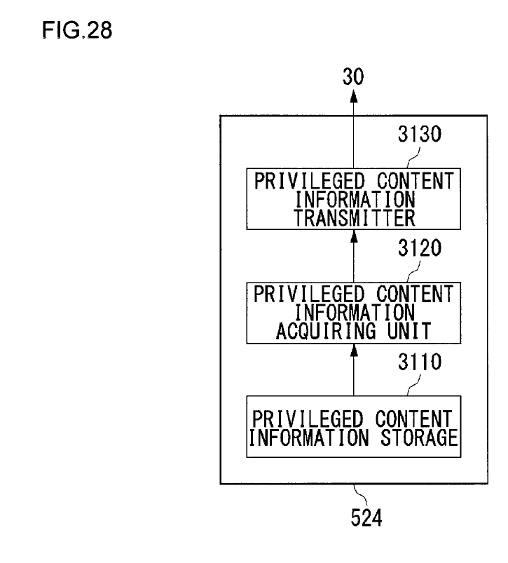

FIG. 28 is a diagram showing an exemplary structure of the privileged information distribution apparatus 524 according to the fourth modification. The privileged information distribution apparatus 524 includes a privileged content information storage 3110, a privileged content information acquiring unit 3120, and a privileged content information transmitter 3130. The privileged content information storage 3110 stores privileged content information. The privileged content information stored therein is referenced by the privileged content information acquiring unit 3120. The privileged content information acquiring unit 3120 acquires the privileged content information stored in the privileged content information storage 3110, and supplies the thus acquired privileged content information to the privileged content information transmitter 3130. The privileged content information transmitter 3130 transmits the privileged content information acquired from the privileged content information acquiring unit 3120, to the terminal apparatus 30 through the short-distance radio communication network.

An operation of the terminal apparatus 30 in the fourth distribution system is almost the same as the processing shown in the flowchart of FIG. 21 and therefore the depiction thereof is omitted. What differs from the flowchart of FIG. 21 is that if the privileged content information is received in the processing of S402 and privileged contents corresponding to the received privileged content information are received, the terminal apparatus 30 will decode the privileged contents using the decryption keys contained in the received privileged content information.

The information distribution apparatus 520 installed near the exit may distribute messages or contents such as “thank you for visiting us. Come visit us again” through the short-distance radio communication network.

According to this modification, the terminal apparatus 30 can easily acquire the contents that can be viewed and listened to only when a specific condition is met. The specific condition includes a case where the user moves to a specific location or encounters a specific person. Also, the communication contents are encrypted and then the encrypted communication contents are distributed and decryption keys used to decode them are appended to the content information. As a result, only the users who have acquired the content information can view and listen to said contents. In this fourth embodiment, the capability of connecting to a privileged information distribution apparatus is a specific condition. However, it suffices if whether the condition is met or not and whether a decryption key is to be handed or not are brought to correspondence therebetween. Thus, a conditioning may be used where decryption key information can be obtained through data broadcasting if a specific content is viewed or where the decryption key information can be obtained using a technique such as QR (Quick Response) code if the image of a specific location is shot by a camera.

(Fifth Modification)

Next, a description will be given of a fifth modification. Note that the components identical to those in the above-described embodiment or modifications are given the identical reference numerals, and the descriptions thereof are simplified. Firstly, an outline explanation is given. The fifth modification relates to a fifth distribution system. The fifth distribution system includes a terminal apparatus, a WLAN base station apparatus, and a content supply apparatus. The fifth distribution system is of a structure excluding the information distribution apparatus from the communication system 100 of the embodiment. In the communication system 100, the terminal apparatus 30 acquires the connection setting information from the information distribution apparatus 520. In contrast thereto, in the fifth distribution system, the terminal apparatus 30 acquires the connection setting information from the WLAN base station apparatus 60. The terminal apparatus connects to a WLAN communication network based on the connection setting information acquired from the WLAN base station apparatus 60. The terminal apparatus also acquires content information from the WLAN base station apparatus 60.

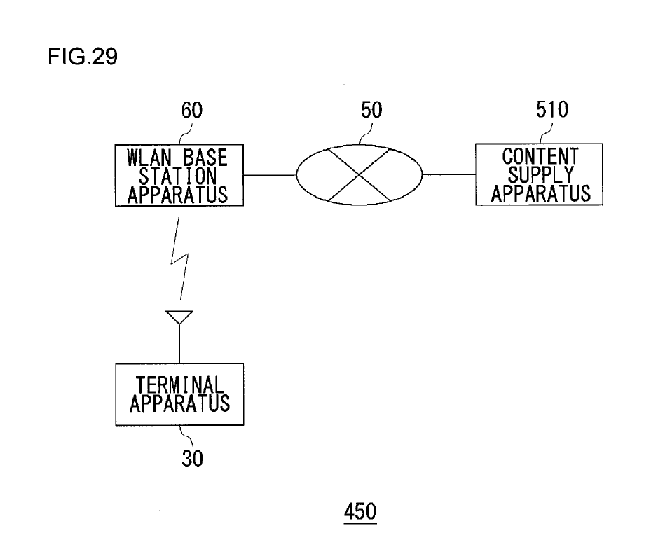

FIG. 29 is a diagram showing an exemplary structure of a fifth distribution system 450 according to the fifth modification. The fifth distribution system 450 includes a terminal apparatus 30, a WLAN base station apparatus 60, a wide area network 50, and a content supply apparatus 510. As described above, the fifth distribution system 50 is of a structure excluding the information distribution apparatus 520 of the communication system 100. The WLAN base station apparatus 60 transmits connection setting information and content information to the terminal apparatus 30. The terminal apparatus 30 acquires the connection setting information and the content information sent from the WLAN base station apparatus 60. The other processings are similar to those in the communication system 100 and therefore the description thereof is omitted.

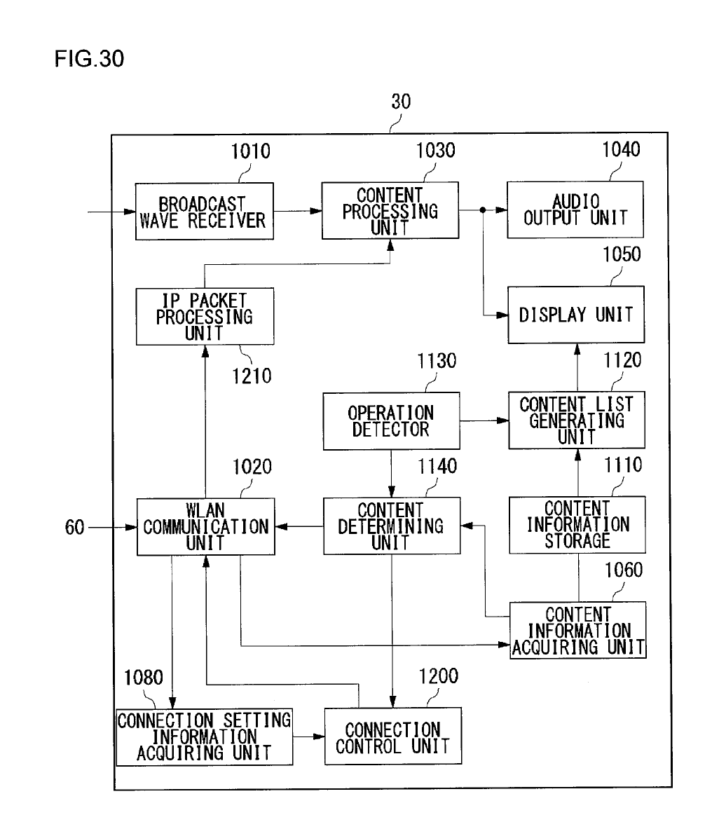

FIG. 30 is a diagram showing an exemplary structure of the terminal apparatus 30 shown in FIG. 29. As compared with the structure shown in FIG. 5, the terminal apparatus 30 differs in the feature that the short-distance radio communication unit 1100 is not provided. The function achieved by the short-distance radio communication unit 1100 shown in FIG. 5 is executed by the WLAN communication unit 1020.

The WLAN communication unit 1020 receives the connection setting information from the WLAN base station apparatus 60. The WLAN communication unit 1020 transmits the received connection setting information to the connection setting information acquiring unit 1080. The WLAN communication unit 1020 receives the content information sent from the WLAN base station apparatus 60, and transmits the received content information to the content information acquiring unit 1060.

The connection setting information acquiring unit 1080 acquires the connection setting information received by the WLAN communication unit 1020. The content information acquiring unit 1060 stores the content information sent from the WLAN communication unit 1020, in the content information storage 1110.

The content information acquiring unit 1060 transfers information on initial content to the content determining unit 1140, based on the content information received from the WLAN communication unit 1020. Further, the content information acquiring unit 1060 requests the content determining unit 1140 to determine the transferred contents as the received contents. The other functions of the terminal apparatus 30 are similar to those of the above-described FIG. 5 and therefore the description thereof is omitted here.

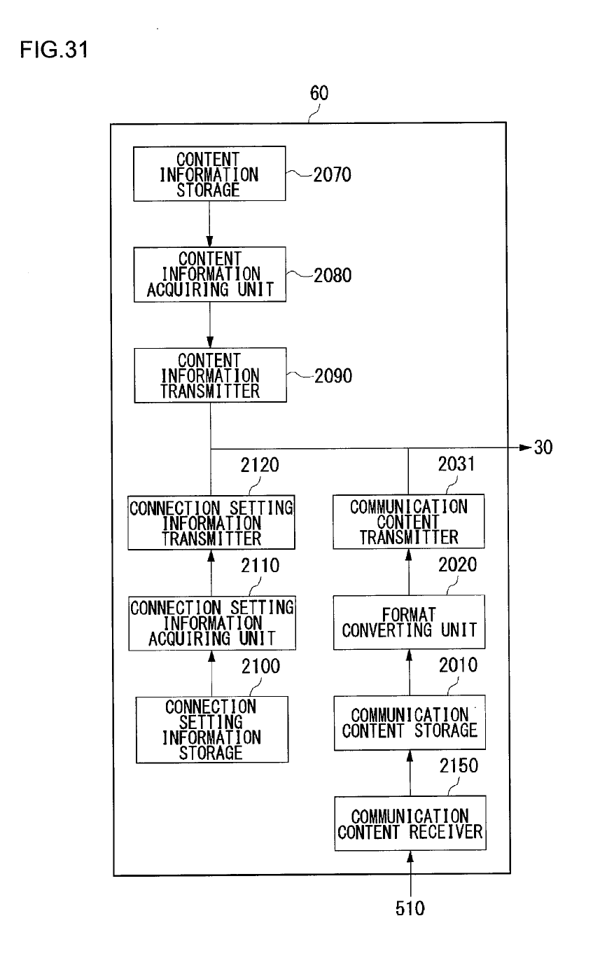

FIG. 31 is a diagram showing an exemplary structure of the WLAN base station apparatus 60 shown in FIG. 29. The WLAN base station apparatus 60 shown in FIG. 31 includes the structure as shown in FIG. 2 and the structure of the information distribution apparatus 520 as shown in FIG. 4. More concretely, the WLAN base station apparatus 60 includes a communication content receiver 2150, a communication content storage 2010, a format converting unit 2020, a communication content transmitter 2031, a content information storage 2070, a content information acquiring unit 2080, a content information transmitter 2090, a connection setting information storage 2100, a connection setting information acquiring unit 2110, and a connection setting information transmitter 2120.

The content information storage 2070 and the connection setting information storage 2100 correspond to the setting information storage 3010 shown in FIG. 3. The content information acquiring unit 2080 and the connection setting information acquiring unit 2110 correspond to the setting information acquiring unit 3020 shown in FIG. 3. The content information transmitter 2090 and the connection setting information transmitter 2120 correspond to the setting information transmitter 3030 shown in FIG. 3. The functions of the content information storage 2070, the content information acquiring unit 2080, the content information transmitter 2090, the connection setting information storage 2100, the connection setting information acquiring unit 2110 and the connection setting information transmitter 2120 as well as the functions of the communication content receiver 2150, the communication content storage 2010, the format converting unit 2020 and the communication content transmitter 2031 are similar to those of the above described FIG. 2 or FIG. 4 and therefore the description thereof is omitted here.

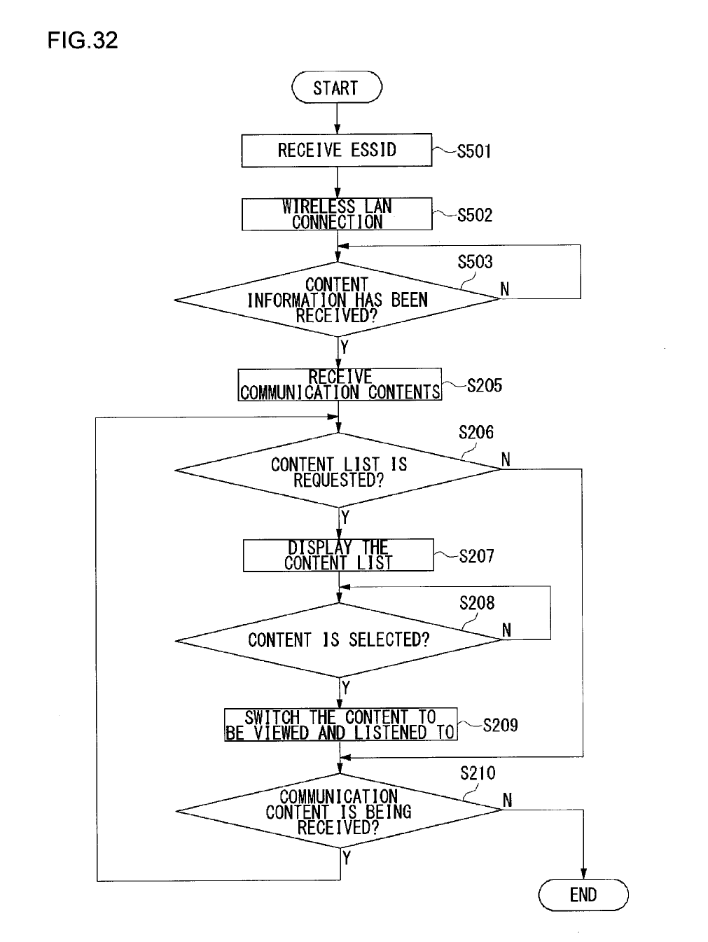

FIG. 32 is a diagram showing an exemplary operation of the terminal apparatus 30 shown in FIG. 29. This flowchart includes the following processings of S501 to S503 in place of S201 to S203 shown in FIG. 9. First, if a user enters a store, the terminal apparatus 30 will receive an ESSID from the WLAN base station apparatus 60 (S501). If the received ESSID agrees with an ESSID which has been set beforehand in the terminal apparatus 30, a connection will be established with a WLAN base station apparatus 60 associated with the received ESSID (S502).

Then, the terminal apparatus 30 waits for a receiving of content information from the WLAN base station apparatus 60 (N of S503). If the content information is received therefrom (Y of S503), the terminal apparatus 30 will set the WLAN communication unit 102 and receive communication contents from the WLAN base station apparatus 60 (S205). The processings after this are similar to those of the flowchart shown in FIG. 8 and therefore the description thereof is omitted.

Note that an AP for providing information on connection with the WLAN communication network may be installed separately. The AP for providing the connection information may be of an ad-hoc mode instead of an infra-mode. In such a case, the terminal apparatus 30 sets the WLAN communication unit 1020 of FIG. 30 to the ad-hoc mode, as a general rule. The WLAN base station apparatus 60 is so set as to function as an AP for exclusive use in the infrastructure mode. In this modification, as soon as the user enters into the store, the terminal apparatus 30 connects to the AP for exclusive use in the ad-hoc mode through the WLAN communication network. Then the terminal apparatus 30 has the WLAN communication unit 1020 switched to the setting of the infrastructure mode. Here, it is only necessary that the terminal apparatus 30 is connected to the WLAN base station apparatus 60 which is an AP for exclusive use in the infrastructure mode which is separately installed from the AP for exclusive use in the ad-hoc mode.

According to this modification, the distribution system can be structured without the provision of the information distribution apparatus, so that cost can be reduced. Also, since components necessary for receiving the connection information on a terminal side is no longer required, the cost for the terminal can be reduced.

In the first to fourth modifications, a description is given of a structure based on the embodiment wherein the structure includes the information distribution apparatus that forms the short-distance radio communication network. However, the structure may be such that the information distribution apparatus is not included as in the fifth modification.

(Sixth Modification)

Next, a description will be given of a sixth modification. Note that the components identical to those in the above-described embodiment or modifications are given the identical reference numerals, and the descriptions thereof are simplified. Firstly, an outline explanation is given. The sixth distribution system is suited for installation in retail stores such as supermarkets. In the sixth distribution system, those who provide services in the retail stores provide terminal apparatuses and manage them. Here, fixed terminal apparatuses are installed in shelves displaying commercial goods, and terminal apparatuses are installed in shopping carts used by shoppers.

The sixth modification differs from the above-described embodiment and modifications in the features that the content distribution apparatus distributes content information and control information by multicast and that the fixed terminal apparatuses hold the contents therewithin. Note that the control information to be distributed contains information with which to specify contents to be reproduced by each terminal apparatus. According to this modification, a flexible system architecture is feasible and the retail stores or the like can efficiently provide appropriate information to the users. The detail thereof will be discussed later.

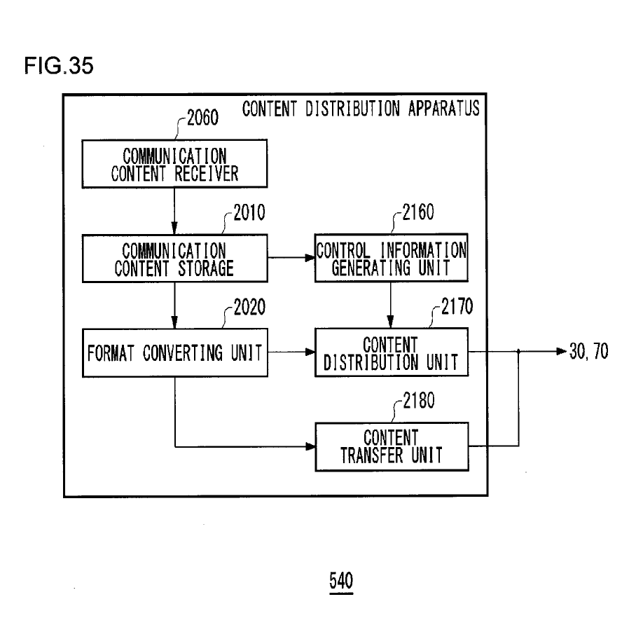

FIG. 35 is a diagram showing an exemplary structure of a sixth distribution system 460 according to the sixth modification. The sixth distribution system 460 includes a content distribution apparatus 540, APs 530, terminal apparatuses 30, fixed terminal apparatuses 70, a positional information setting apparatus 74, and a data gathering apparatus 72.

The content distribution apparatus 540 transmits contents, content information and control information using multicast. Similarly to the embodiment and the modifications, the content information is information that contains content IDs, content names, IP addresses and port numbers. The content information in this sixth modification is distributed from the content distribution apparatus 540 using multicast. The control information is information with which to specify to the fixed terminal apparatuses 70 and the terminal apparatuses 30 which content is to be received and reproduced.

The data gathering apparatus 72 and the positional information setting apparatus 74 perform communications with the terminal apparatus 30 and the fixed terminal apparatus 70, respectively, using a short-distance radio communication scheme. The positional information setting apparatus 74 transmits positional information to the fixed terminal apparatus 70. The positional information contains area information indicating the location where this fixed terminal apparatus 70 is installed and connection setting information with which to connect to a base station installed in the vicinity of said location. The positional information setting apparatus 74 is operated by a salesperson of the retail store or the like. The salesperson enters the location where this fixed terminal apparatus 70 is installed, to the positional information setting apparatus 74 and transmits the positional information.

The fixed terminal apparatus 70 or the terminal apparatus 30 communicate with the AP 530 via wireless LAN. The fixed terminal apparatus 70 and the terminal apparatus 30 receive the communication contents, the content information and the control information from the AP 530. The terminal apparatus 30 and the fixed terminal apparatus 70 communicate with each other using the short-distance radio communication scheme.

The fixed terminal apparatus 70 may transmit positional information in answer to a request from the terminal apparatus 30. The terminal apparatus 30 may change the contents to be received or the access point, based on the positional information thus sent. In concrete terms, the terminal apparatus 30 acquires the positional information associated with the position where the terminal apparatus itself 30 is located, from a fixed terminal apparatus installed near the terminal apparatus 30 using a predetermined short-distance radio communication. Self-contained contents held by the fixed terminal apparatus 70 are transferred from the content distribution apparatus 540. This transfer processing may be executed using unicast during nighttime or the like while normal multicast distribution is not performed.

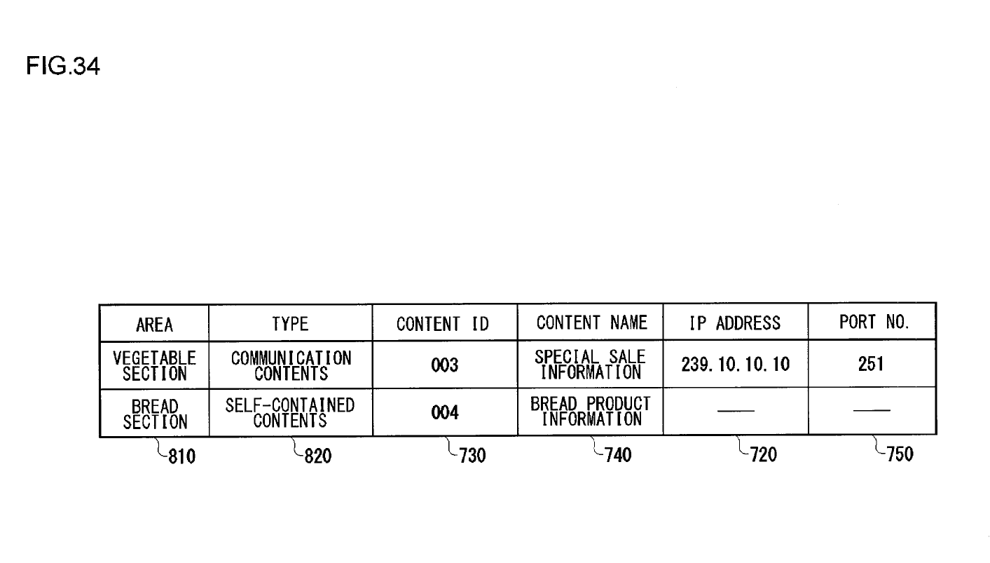

FIG. 34 is a diagram showing an example of control information according to the sixth modification. This control information contains information set for each area. More specifically, the control information contains an area column 810, a type column 820, a content ID column 730, a content name column 740, an IP address column 720, and a port no. column 750.

The type column 820 indicates the type of contents. The types of contents include communication contents and self-contained contents. The communication contents are contents multicast-distributed by an apparatus which is to distribute information. The self-contained contents are contents stored in an internal memory of the fixed terminal apparatus 70.

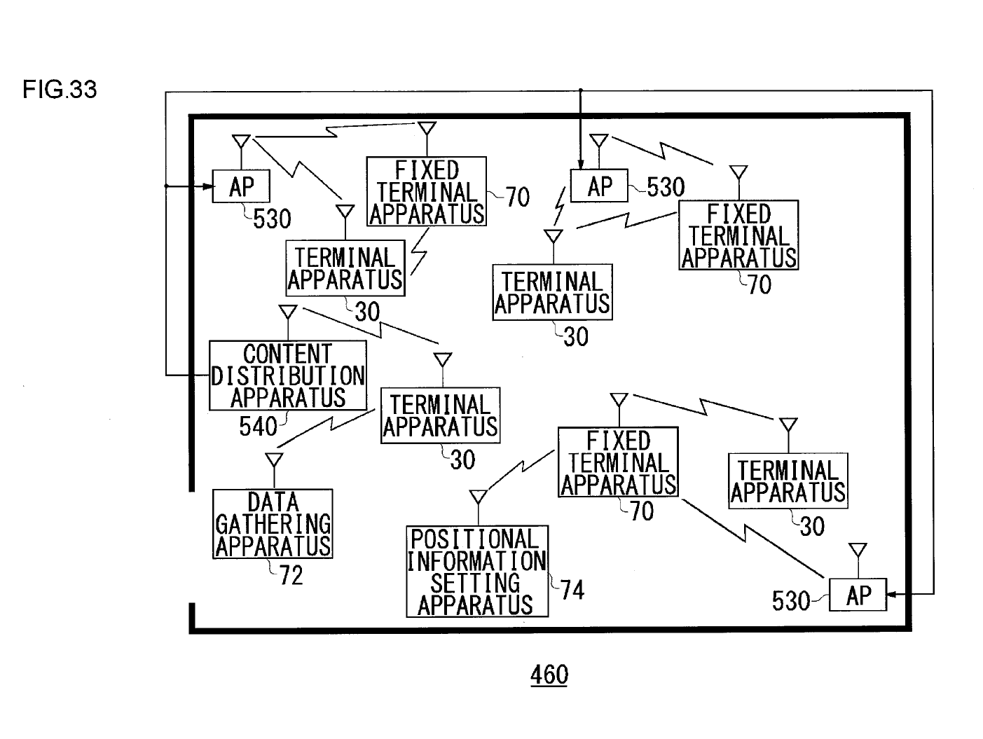

FIG. 35 is a diagram showing an exemplary structure of the content distribution apparatus 540 of FIG. 33. The content distribution apparatus 540 includes a communication content storage 2010, a format converting unit 2020, a communication content receiver 2060, a control information generating unit 2160, a content distribution unit 2170, and a content transfer unit 2180. The communication content receiver 2060, the communication content storage 2010 and the format converting unit 2020 are similar to those of the previously described modifications and therefore the description thereof is omitted here.

The control information generating unit 2160 generates content information and control information, and requests the content distribution unit 2170 to distribute them by multicast. The content distribution unit 2170 distributes the communication contents, which have been converted by the format converting unit 2020, and the content information and control information generated by the control information generating unit 2160, using multicast.

The content transfer unit 2180 transfers the contents stored in the communication content storage 2010, to the fixed terminal apparatuses 70. This transfer is done using unicast instead of multicast. Which contents are to be transferred to which fixed terminal apparatus 70 shall be determined by following the instructions of salespersons or the like inputted to a not-shown user interface. As a salesperson enters an instruction about the transfer of one or a plurality of contents, the content transfer unit 2180 transfers the contents successively during the time while normal multicast distribution is not performed.

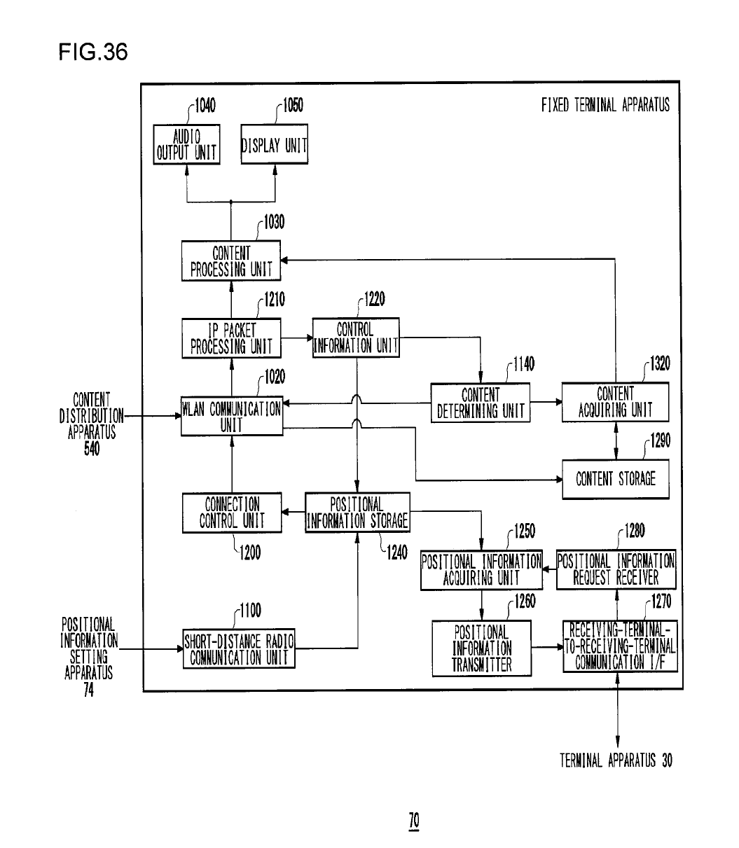

FIG. 36 is a diagram showing an exemplary structure of a fixed terminal apparatus 70 of FIG. 33. The fixed terminal apparatus 70 includes a content processing unit 1030, an audio output unit 1040, a display unit 1050, an IP packet processing unit 1210, a control information processing unit 1220, a WLAN communication unit 1020, a content determining unit 1140, a content acquiring unit 1300, a connection control unit 1200, a positional information storage 1240, a content storage 1290, a short-distance radio communication unit 1100, a positional information acquiring unit 1250, a positional information transmitter 1260, a receiving-terminal-to-receiving-terminal communication I/F 1270, and a positional information request receiver 1280. Of these components, the content processing unit 1030, the audio output unit 1040, and the display unit 1050 function similarly to those of the previously described modifications, and therefore the description thereof is omitted here.

The IP packet processing unit 1210 processes IP packets received by the WLAN communication unit 1020. In concrete terms, if the received IP packets are part of the communication contents, a request will be made to the content processing unit 1030 to process the IP packets. If, on the other hand, the thus processed IP packet is control information, a request will be made to the control information processing unit 1220 to process the IP packet.

The control information processing unit 1220 receives the request from the IP packet processing unit 1210 and processes the control information. In concrete terms, the control information processing unit 1220 extracts control information concerning the area stored in the positional information storage 1240, namely control information concerning the area where said fixed terminal apparatus 70 is installed, and outputs the information on contents to be reproduced to the content determining unit 1140.

The content determining unit 1140 determines which content is to be reproduced, based on the information on contents received from the control information processing unit 1220. If the content to be reproduced is a communication content, the content determining unit 1140 will request the WLAN communication unit 1020 to receive said content. If, on the other hand, the content to be reproduced is a self-contained content, it will request the content acquiring unit 1300 to acquire and reproduce said self-contained content.

The content storage 1290 stores self-contained contents therein. The content acquiring unit 1300 acquires the self-contained contents stored in the content storage 1290, based on a request from the content determining unit 1140, and requests the content processing unit 1030 to process them. The WLAN communication unit 1020 receives the contents and control information that the content distribution apparatus 54 transmits. When the control information and the contents distributed by the use of multicast have been received, the IP packet processing unit 1210 is requested to process them. On the other hand, when the contents transferred during the nighttime or the like from the content distribution apparatus 540 by unicast have been received, said contents are stored in the content storage 1290 as self-contained contents.

The short-distance radio communication unit 1100 communicates with the positional information setting apparatus 74. As the short-distance radio communication unit 1100 receives positional information from the positional information setting apparatus 74, this positional information is stored in the positional information storage 1240. The positional information storage 1240 stores the positional information received via the short-distance radio communication unit 1100. The positional information is information on a location where the fixed terminal apparatus 70 in question is installed, and contains area information indicating a position and connection setting information with which to connect to the content distribution apparatus 540.

In this sixth modification, no AP is provided but an AP that relays the communication contents may be provided. If such an AP is provided, an AP to connect per area or a content distribution apparatus may be set. The positional information may contain connection setting information with which to connect to these APs or the content distribution apparatus. Also, the positional information may be referenced from the control information processing unit 1229 when the control information corresponding to its own AP is to be extracted. Also, the positional information may be referenced from the positional information acquiring unit 1250 when the positional information is to be sent in response to a request from a terminal apparatus 30.

The receiving-terminal-to-receiving-terminal communication I/F 1270 performs a communication between a fixed terminal apparatus 70 and a terminal apparatus 30. If a positional information request is received from the terminal apparatus 30, the content thereof will be outputted to the positional information request receiver 1280. Based on the request from the positional information transmitter 1260, the positional information is sent to the terminal apparatus 30 that has sent the positional information request.

As the positional information request receiver 1280 receives the positional information request from the receiving-terminal-to-receiving-terminal communication I/F 1270, it requests the positional information acquiring unit 1250 to acquire the positional information. The positional information acquiring unit 1250 acquires its own positional information from the positional information storage 1240, based on the request from the positional information request receiver 1280, and outputs this positional information to the positional information transmitter 1260. The positional information transmitter 1260 requests the receiving-terminal-to-receiving-terminal communication I/F 1270 to transmit the positional information received from the positional information acquiring unit 1250.

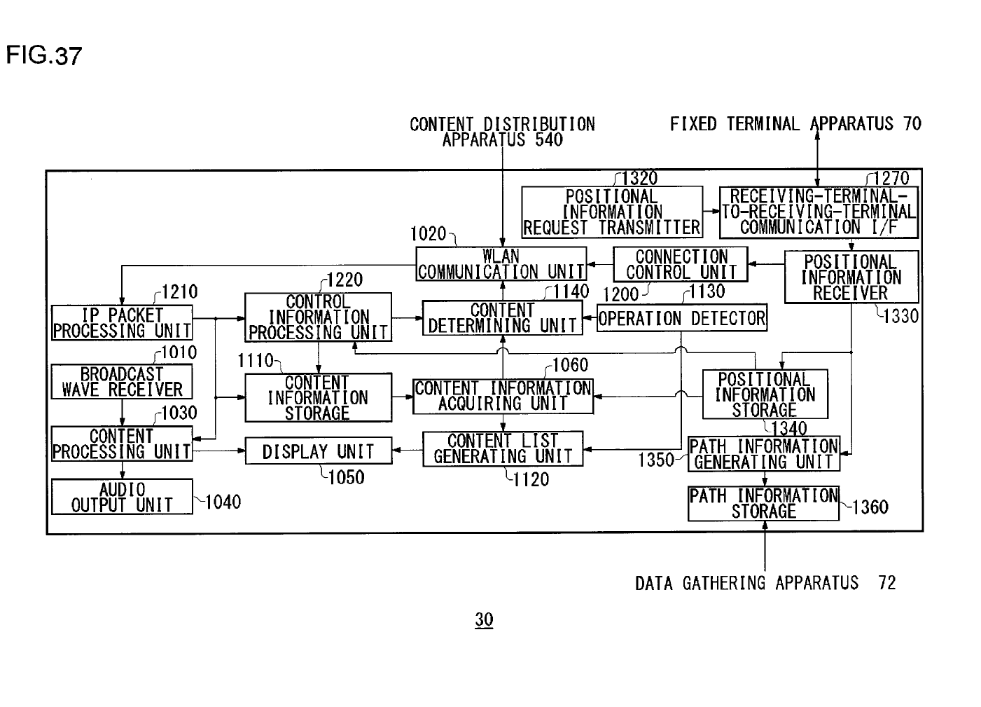

FIG. 37 is a diagram showing an exemplary structure of the terminal apparatus 30 of FIG. 33. The terminal apparatus 30 includes a broadcast wave receiver 1010, a WLAN communication unit 1020, a content processing unit 1030, an audio output unit 1040, a display unit 1050, a content information acquiring unit 1060, a content information storage 1110, a content list generating unit 1120, an IP packet processing unit 1210, a control information processing unit 1220, an operation detector 1130, a connection control unit 1200, a receiving-terminal-to-receiving-terminal communication I/F 1270, a positional information request transmitter 1320, a positional information receiver 1330, a positional information storage 1340, a path information generating unit 1350, a path information storage 1360, and a content determining unit 1140.

Of these components, the WLAN communication unit 1020, the content information storage 1110, the broadcast wave receiver 1010, the content processing unit 1030, the audio output unit 1040, the display unit 1050, the content list generating unit 1120, the content information acquiring unit 1060, and the operation detector 1130, and the connection control unit 1200 function similarly to those of the previously described modifications, and therefore the description thereof is omitted here.

The IP packet processing unit 1210 processes IP packets received by the WLAN communication unit 1020. If the processed IP packets are part of the communication contents, a request will be made to the content processing unit 1030 to process the IP packets. If, on the other hand, the thus processed IP packet is content information, the content thereof will be stored in the content information storage 1110. If it is control information, a request will be made to the control information processing unit 1220 to process the IP packet.

As soon as the control information processing unit 1220 receives control information from the IP packet processing unit 1210, it extracts control information associated with its own area. In concrete terms, the control information processing unit 1220 extracts control information associated with area information contained in the positional information stored in the positional information storage 1340. Then it outputs information on the content indicated by this control information to the content determining unit 1140 and requests the content determining unit 1140 to reproduce the information.

The content determining unit 1140 determines which content is to be reproduced, based on the request from the control information processing unit 1220 or the operation detector 1130. In concrete terms, contents based on a request from the content determining unit 1140 are received and reproduced. However, if an operation concerning specifying a content by a user is detected in the operation detector, said content is received and reproduced. Also, if the request from the control information processing unit 1220 is the reproduction of a self-contained content, a predetermined communication content instead of the self-contained content will be received and reproduced. The other processings are similar to those in the content determining unit of the fixed terminal apparatus 70.

The receiving-terminal-to-receiving-terminal communication I/F 1270 performs a communication with a fixed terminal apparatus 70 installed on the periphery. A positional information request is transmitted to the fixed terminal apparatus 70, based on a request from the positional information request transmitter 1320. As the positional information transmitted from the fixed terminal apparatus 70 is received in response to this positional information request, this positional information is outputted to the positional information receiver 1330.

The positional information request transmitter 1320 transmits periodically the positional information request to a fixed terminal apparatus 70 located on the periphery. The positional information receiver 1330 receives the positional information that the fixed terminal apparatus 70 transmits. The positional information thus received is stored in the positional information storage 1340. If the connection setting information contained in the received positional information differs from the information on the content distribution apparatus or AP which is presently connected, a request will be made to the connection control unit 1200 to change the access point. The area information contained in the received positional information is sent to the path information generating unit 1350 and is used in the generation of path information when the path information indicating the moving path of said terminal apparatus 30 is generated.

The positional information storage 1340 stores positional information that the positional information receiver 1330 has received from the fixed terminal apparatus 70. When the control information processing unit 1220 extracts control information corresponding to this terminal apparatus 30, the stored positional information references the area information. The path information generating unit 1350 generates moving path information on its own moving path, based on the area information received by the positional information receiver 1330, and stores the moving path information in the path information storage 1360. The path information storage 1360 stores the path information generated by the path information generating unit 1350. The path information stored is sent to the data gathering apparatus through short-distance radio communication, and may serve as reference for future sales promotion and the like.

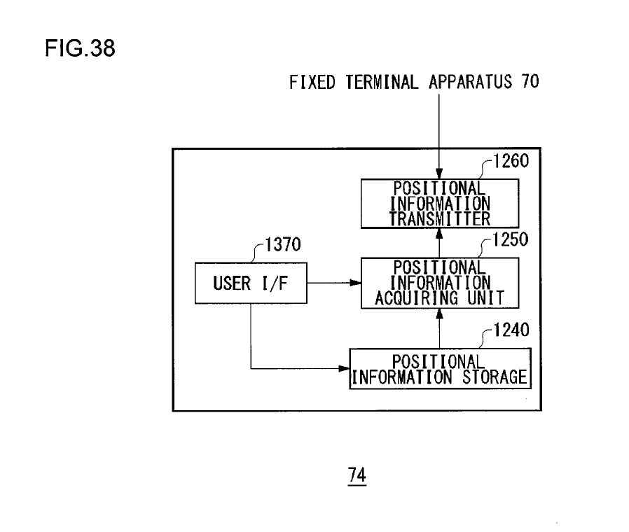

FIG. 38 is a diagram showing an exemplary structure of the positional information setting apparatus 74 of FIG. 33. As shown in FIG. FIG. 38, the positional information setting apparatus 74 includes a user I/F 1370, a positional information storage 1240, a positional information acquiring unit 1250, and a positional information transmitter 1260.

The user I/F 1370 receives instructions from users. When a user specifies an area and gives an instruction of sending the positional information associated with said area to the fixed terminal apparatus 70, the user I/F 1370 requests the positional information acquiring unit 1250 to acquire the specified positional information. The positional information storage 1240 stores positional information on a plurality of areas. User's making an entry to the user I/F 1370 produces this positional information.

The positional information acquiring unit 1250 acquires the corresponding positional information from the positional information storage 1240, based on a request from the user I/F 1370, and requests the positional information transmitter 1260 to transmit it. Based on a request from the positional information acquiring unit 1250, the positional information transmitter 1260 transmits the positional information to the fixed terminal apparatus 70 through short-distance radio communication.

Though in this modification the connection setting information is acquired from the positional information setting apparatus 74 or the fixed terminal apparatus 70, the fixed terminal apparatus 70 and the terminal apparatus 30 may store the connection setting information beforehand. In this sixth modification, no AP is provided but an AP may be provided similarly to the other examples. In such a case, the AP functions to transfer the contents received from the content distribution apparatus, to the terminal apparatus 30 or the fixed terminal apparatus 70.

Though the self-contained contents stored in the fixed terminal apparatus 70 are transferred from the content distribution apparatus 540 during nighttime or the like using unicast, the self-contained contents may be transferred to the fixed terminal apparatus through the recording medium such as a DVD (Digital Video Disk). Though transfer instructions are inputted to the content distribution apparatus, the instructions may be inputted to an external control server similarly to a tenth modification (described later) if the external control server connected via a network is provided. Moreover, information that indicates the reproduction start and the reproduction end of a content may be transmitted as the control information. The control information to be sent may include not only information set for each area but also an instruction for each terminal.

(Seventh Modification)

Next, a description will be given of a seventh modification. Note that the components identical to those in the above-described embodiment or modifications are given the identical reference numerals, and the descriptions thereof are simplified. Firstly, an outline explanation is given. The seventh modification relates to a seventh distribution system.

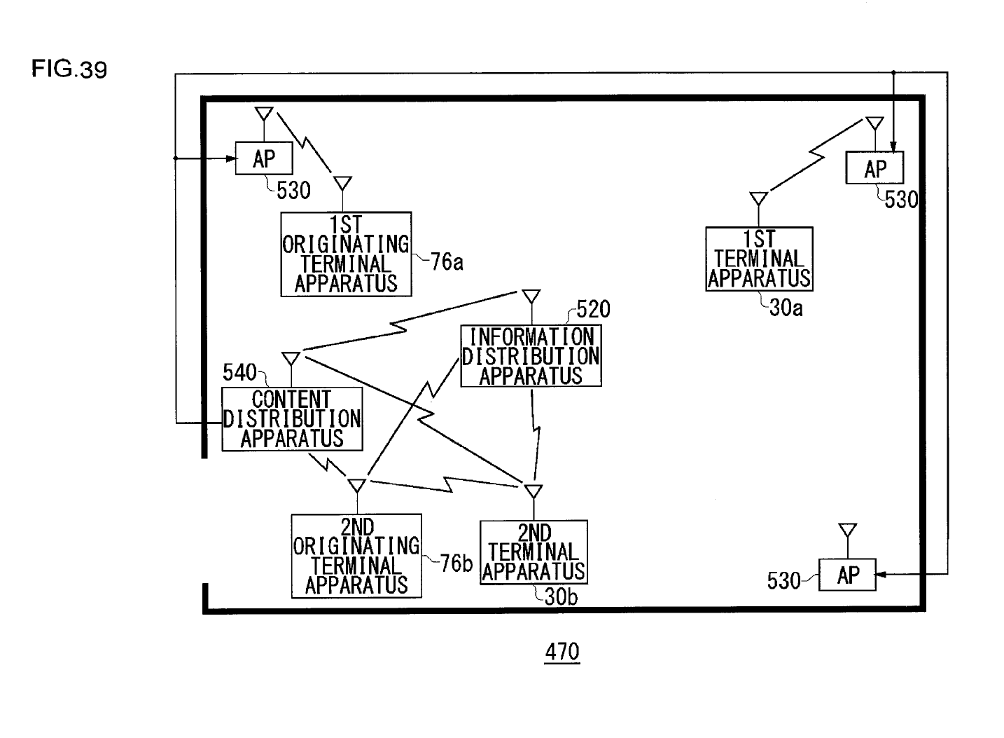

FIG. 39 is a diagram showing an exemplary structure of a seventh distribution system 470 according to the seventh modification. The seventh distribution system 470 includes a content distribution apparatus 540, an information distribution apparatus 520, an AP 530, a first terminal apparatus 30a and a second terminal apparatus 30b, which are represented by “terminal apparatus 30”, a first originating terminal apparatus 76a and a second originating terminal apparatus 76b, which are represented by “originating terminal apparatus 76”.

This modification is suited for services in a large area such as theme parks. The seventh modification differs from the above-described embodiment and modifications in the feature that contents shot by an originating terminal apparatus 76 that a user carries with himself/herself are distributed. According to such a modification as this, the user can distribute his/her own contents to the terminals within a predetermined area.

The terminal apparatus 30 and the originating terminal apparatus 76 acquire connection setting information from the information distribution apparatus 520 through short-distance radio transmission and the like. Based on said information, the terminal apparatus 30 and the originating terminal apparatus 76 establish a connection to the content distribution apparatus 540 or AP 530. The originating terminal apparatus 76 requests the content distribution apparatus 540 to assign multicast addresses required for the distribution of contents, and acquires them. The originating terminal apparatus 76 conveys the multicast addresses, acquired from the content distribution apparatus 540, and decryption keys, required for the decoding of encrypted contents that the originating terminal apparatus itself distributes, to the terminal apparatus 30 through short-distance radio transmission and the like.

The terminal apparatus 30 not only receives communication contents distributed from the content distribution apparatus 540 by multicast, similarly to the terminal apparatuses 30 according to the above-described modifications, but also receives independent contents distributed from the originating terminal apparatus 76. Though the content information on communication contents is distributed from the content distribution apparatus 540 by multicast similarly to the sixth modification, the information on independent contents is broadcast from the originating terminal apparatus 76 through short-distance radio transmission. In other words, the terminal apparatus 30 can receive and reproduce the independent contents from only the originating terminal apparatus 76 from which the information is being broadcast through short-distance radio transmission. Note that the content information on independent contents not only contains the content information on communication contents but also contains decryption keys and the like required by the terminal apparatus 30 for the decoding of independent contents.

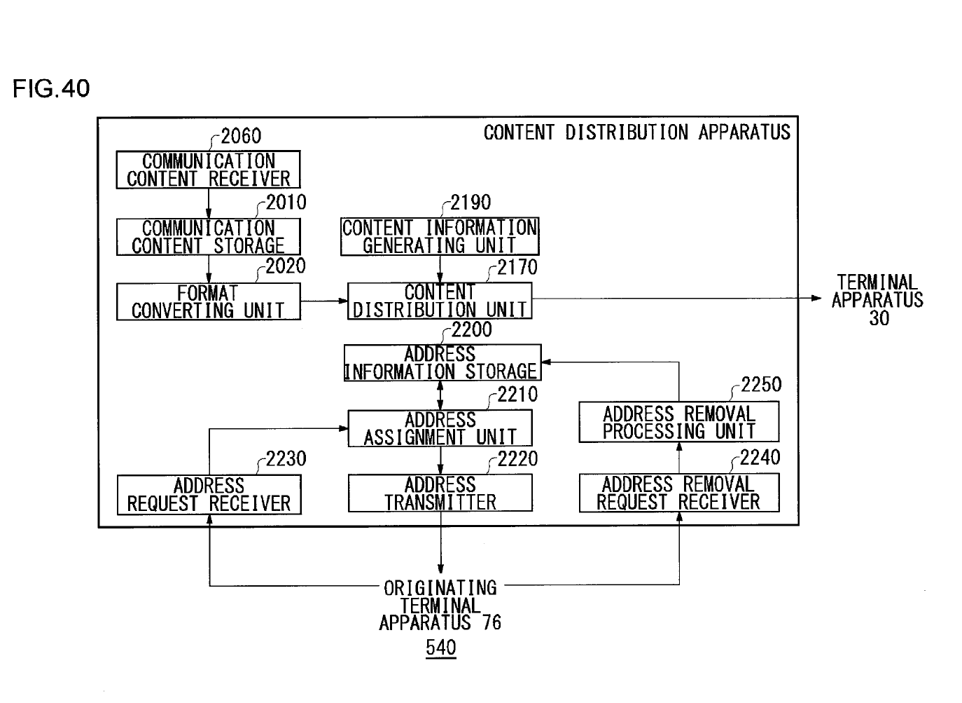

FIG. 40 is a diagram showing an exemplary structure of the content distribution apparatus 540 of FIG. 39. The content distribution apparatus 540 includes a communication content receiver 2060, a communication content storage 2010, a format converting unit 2020, a content information generating unit 2190, a content distribution unit 2170, an address information storage 2200, an address assignment unit 2210, an address transmitter 2220, an address request receiver 2230, an address removal request receiver 2240, and an address removal processing unit 2250.

Of these structural components, the communication content receiver 2060, the communication content storage 2010, the format converting unit 2020 and the content distribution unit 2170 function similarly to those in other examples, and therefore the description thereof is omitted here.

The content information generating unit 2190 generates content information and requests the content distribution unit 2170 to distribute it. In this seventh modification, the control information is not distributed. Also, in this seventh modification, no instruction is given from the content distribution apparatus 540 to the terminal apparatus 30 as to which content is to be received and reproduced.

The address request receiver 2230 receives an address request from the originating terminal apparatus 76. Upon receipt of the address request, the address assignment unit 2210 is requested to assign an address to the originating terminal apparatus 76 which is the sender thereof.

Based on the request from the address request receiver 2230, the address assignment unit 2210 assigns a multicast address to the originating terminal apparatus 76. More specifically, in consideration of the multicast addresses which are presently used among those stored in the address information storage 2200, an address which is usable as a multicast address but not stored therein is assigned. The address transmitter 2220 is requested to transmit the thus assigned multicast address. The address assignment unit 2210 stores the thus assigned multicast address in the address information storage 2200. The address information storage 2200 stores the information on the address assigned that the address assignment unit has assigned to the originating terminal apparatus 76. The address information stored therein is added and referenced by the address assignment unit 2210 and deleted by the address removal processing unit 2250.

Based on a request from the address assignment unit 2210, the address transmitter 2220 transmits the address information. The address removal request receiver 2240 receives an address removal request sent from the originating terminal apparatus 76 whose multicast address is no longer in use, and requests the address removal processing unit 2250 to delete the information on this unwanted multicast address. Based on the request from the address removal request receiver 2240, the address removal processing unit 2250 removes the multicast address which is no longer in use, from the information stored in the address information storage 2200.

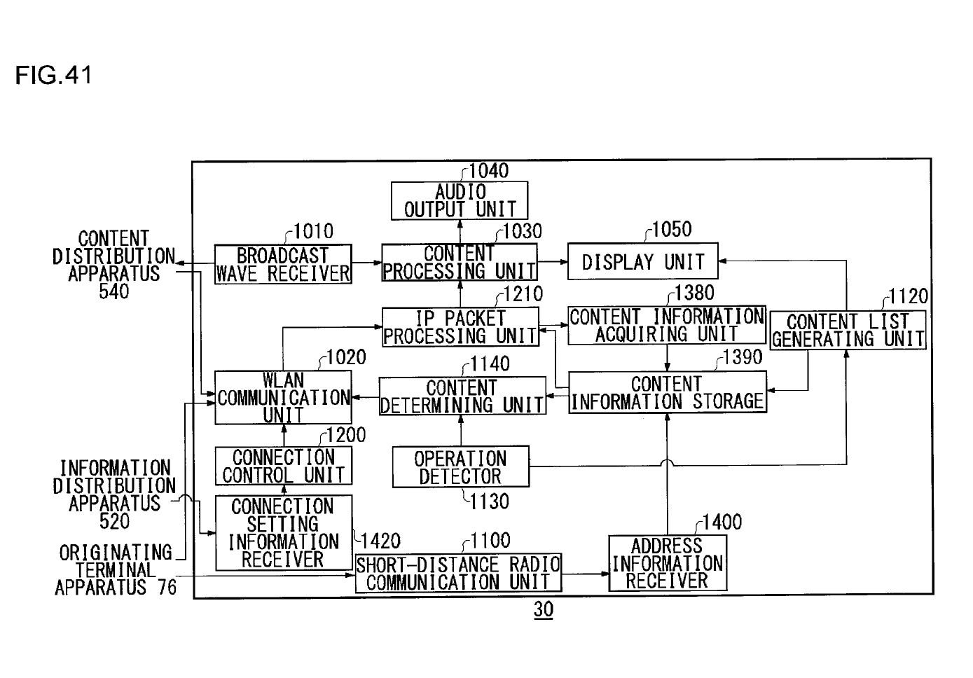

FIG. 41 is a diagram showing an exemplary structure of the terminal apparatus 30 of FIG. 39. The terminal apparatus 30 includes a broadcast wave receiver 1010, a WLAN communication unit 1020, a content processing unit 1030, an audio output unit 1040, a display unit 1050, an IP packet processing unit 1210, a content information acquiring unit 1380, a content list generating unit 1120, a content determining unit 1140, a content information storage 1390, a connection control unit 1200, an operation detector 1130, a connection setting information receiver 1420, a short-distance radio communication unit 1100, and an address information receiver 1400.

Of these structural components, the broadcast wave receiver 1010, the WLAN communication unit 1020, the audio output unit 1040, the display unit 1050, the connection control unit 1200, the operation detector 1130, the content list generating unit 1120 and the content determining unit 1140 function similarly to those in the other modifications, and therefore the description thereof is omitted here.

The IP packet processing unit 1210 processes IP packets received by the WLAN communication unit 1020. If the thus processed IP packets are part of the communication contents, a request will be made to the content processing unit 1030 to process the IP packets. If the thus processed IP packet is control information, a request will be made to the content information acquiring unit 1380 to process the IP packet. The content processing unit 1030 processes the contents, based on a request from the IP packet processing unit 1210. The contents are processed similarly to other examples; but if a content to be processed is an independent content, such processing will be carried out after the decoding processing is carried out using a decryption key for this independent content stored in the content information storage 1390.

The content information acquiring unit 1380 acquires the content information, based on a request from the IP packet processing unit 1210, and stores it in the content information storage 1390. The content information storage 1390 stores the content information therein. The content information is enrolled by the content information acquiring unit 1380 and the address information receiver 1400. The content information is referenced by the content list generating unit 1120 when a content list is generated, and the content information is referenced by the content determining unit 1140 when contents to be received are determined.

The short-distance radio communication unit 1100 communicates with the originating terminal apparatus 76 through short-distance radio communication. The address information receiver 1400 acquires address information, on a multicast address through which an independent content transmitted by the originating terminal apparatus 76 is distributed, and a decryption key used to decode the encrypted independent content. The thus acquired address information and decryption key are enrolled in the content information storage 1390 as content information on independent contents.

The connection setting information receiver 1420 receives the connection setting information from the information distribution apparatus 520, and outputs the content thereof to the connection control unit 1200.

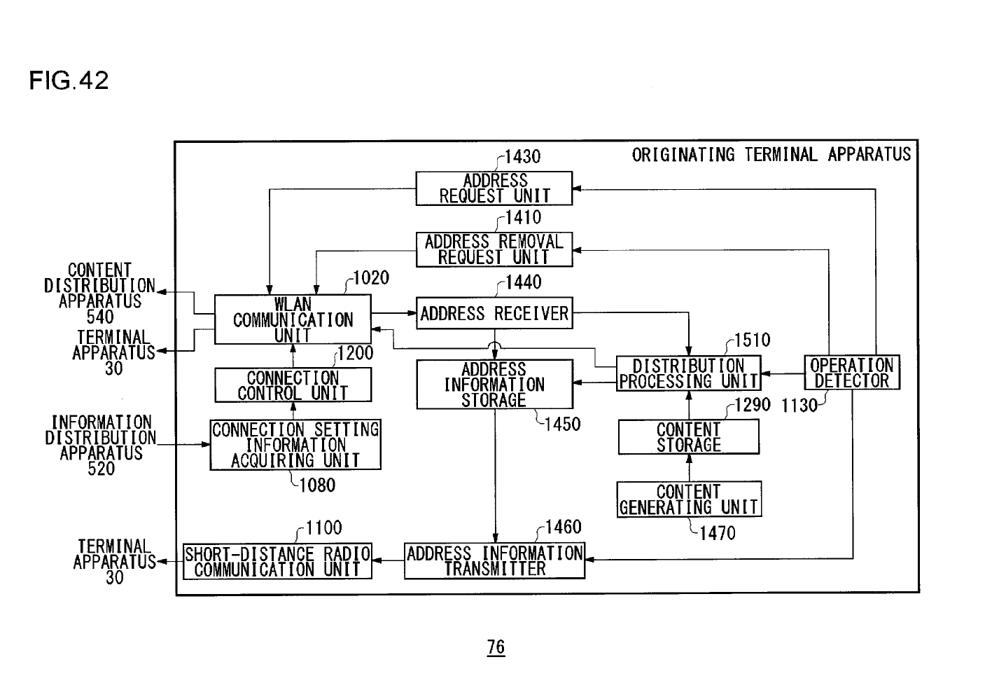

FIG. 42 is a diagram showing an exemplary structure of the originating terminal apparatus 76 of FIG. 39. The originating terminal apparatus 76 includes an address request unit 1430, a WLAN communication unit 1020, an address receiver 1440, a connection control unit 1200, an address information storage 1450, a distribution processing unit 1510, an operation detector 1130, a connection setting information acquiring unit 1080, an address removal request unit 1410, a content storage 1290, a content generating unit 1470, an address information transmitter 1460, and a short-distance radio communication unit 1100.

The WLAN communication unit 1020 performs communications through WLAN. The connection setting information acquiring unit 1080 receives connection setting information from the information distribution apparatus 520. The connection setting information is similar to the connection setting information described in other examples. The connection setting information acquired is sent to the connection control unit 1200.

The connection control unit 1200 performs a connection processing with the content distribution apparatus 540, based on the connection setting information received from the connection setting information acquiring unit 1080. When the operation detector 1130 detects an instruction requesting an address, the address request unit 1430 requests a multicast address used for the content distribution, to the content distribution apparatus 540.

The address receiver 1440 receives the address information that the content distribution apparatus 540 transmits according to an address request made by the address request unit 1430. The received address information is stored in the address information storage 1450. The address information storage 1450 stores the address information and the decryption key received by the address receiver 1440. The address information and decryption key stored therein are referenced when the distribution processing unit 1510 distributes the contents and when the address information transmitter 1460 transmits the address information to the terminal apparatus 30. When the operation detector 1130 detects an instruction requesting the transmission of an address, the address information transmitter 1460 acquires the address information stored in the address information storage 1450 and then requests the short-distance radio communication unit 1100 to transmit it. When the distribution of contents has been completed and thus the multicast address is no longer in use, the address removal request unit 1410 requests the originating terminal apparatus 76 to delete the address via the short-distance radio communication unit 1100.

Based on the request from the address information transmitter 1460, the short-distance radio communication unit 1100 transmits the address information to specific terminal apparatuses 30. Here, only the terminal apparatuses 30 to which the address information has been sent can receive and reproduce the independent content that this originating terminal apparatus 76 distributes.

The content generating unit 1470 maintains the function of picking up images and generates contents. The content storage 1290 stores the contents generated by the content generating unit 1470. The distribution processing unit 1510 requests the WLAN communication unit 1020 to distribute the independent contents stored in the content storage 1290, to the multicast addresses stored in the address information storage 1450.

### Eighth Embodiment

Next, a description will be given of an eighth modification. Note that the components identical to those in the above-described embodiment or modifications are given the identical reference numerals, and the descriptions thereof are simplified. Firstly, an outline explanation is given. The eighth distribution system is suited for installation inside trains or the like.

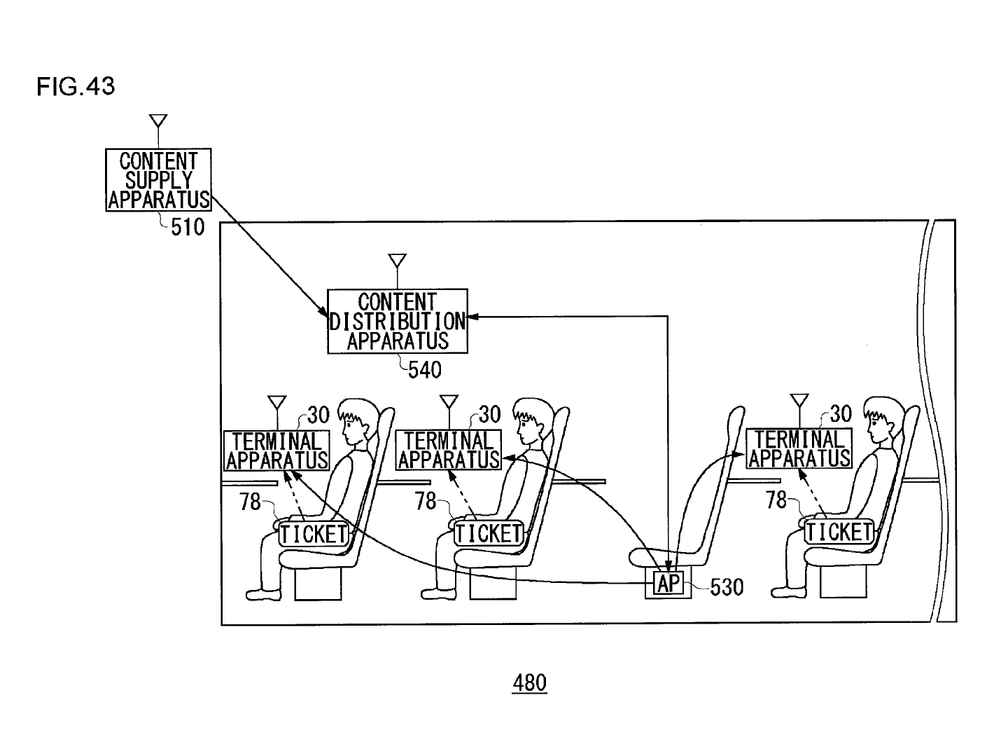

FIG. 43 is a diagram showing an exemplary structure of an eighth distribution system 480 according to an eighth modification. The eighth distribution system 480 includes a content supply apparatus 510, a content distribution apparatus 540, an AP 530, a terminal apparatus 30, and a ticket 78. The content supply apparatus 510 and the AP 530 are similar to those of the previously described modifications and therefore the description thereof is omitted here.

The content distribution apparatus 540 distributes contents by multicast via the AP 530. The communication contents to be delivered in this eighth modification may be travel information contents including present locations and arrival times at major stops, station information contents including transfer guide and information on neighboring areas, or contents indicating information concerning vehicle facilities and how crowded the vehicle/trains are, for instance. Such contents are held and distributed by the content distribution apparatus 540, and the content distribution apparatus 540 acquires these contents from the content supply apparatus 510.

The terminal apparatus 30 receives communication contents distributed by the content distribution apparatus 540, via the AP 530. The terminal apparatus 30, equipped with a function of reading a QR code recorded on the ticket 78, acquires connection setting information and destination information from this QR code. The destination information may include the names of stations to get on, stopover stations, or information concerning stations where users are scheduled to get off. The terminal apparatus 30 connects to the AP 530, based on the connection setting information acquired from the QR code.

The terminal apparatus 30 reproduces preferentially a communication content concerning the station associated with the information on the destination acquired from the QR code. Here, producing it preferentially means that it is received in a state prior to the selection of the content to be viewed and listened to by the user, namely in the initial state, and it is displayed on an upper part of a screen so that the user can easily select it when a content list is displayed. Note that in this eighth modification, the AP 530 and the terminal apparatus 30 may communicate with each other through Bluetooth. Also, the contents according to the eighth modification may be delivered on the station premises.

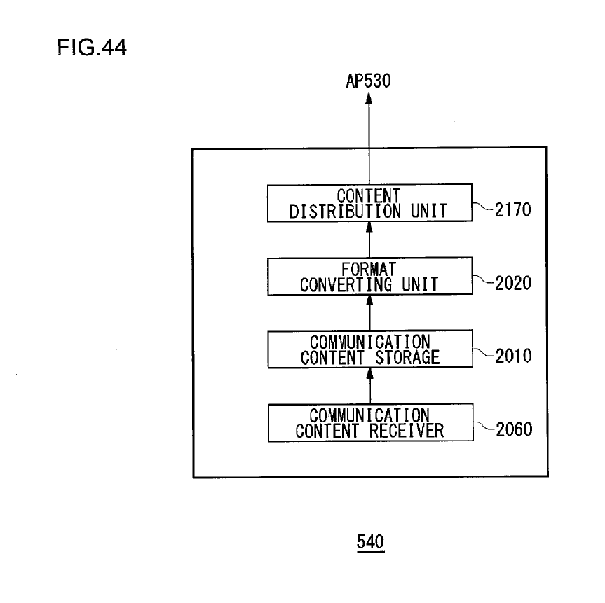

FIG. 44 is a diagram showing an exemplary structure of the content distribution apparatus 540 of FIG. 43. The content distribution apparatus 540 includes a communication content receiver 2060, a communication content storage 2010, a format converting unit 2020, and a content distribution unit 2170. The content distribution apparatus 540 according to this eighth modification is almost the same as the content distribution apparatus 540 according to the above-described embodiment and therefore the description thereof is omitted.

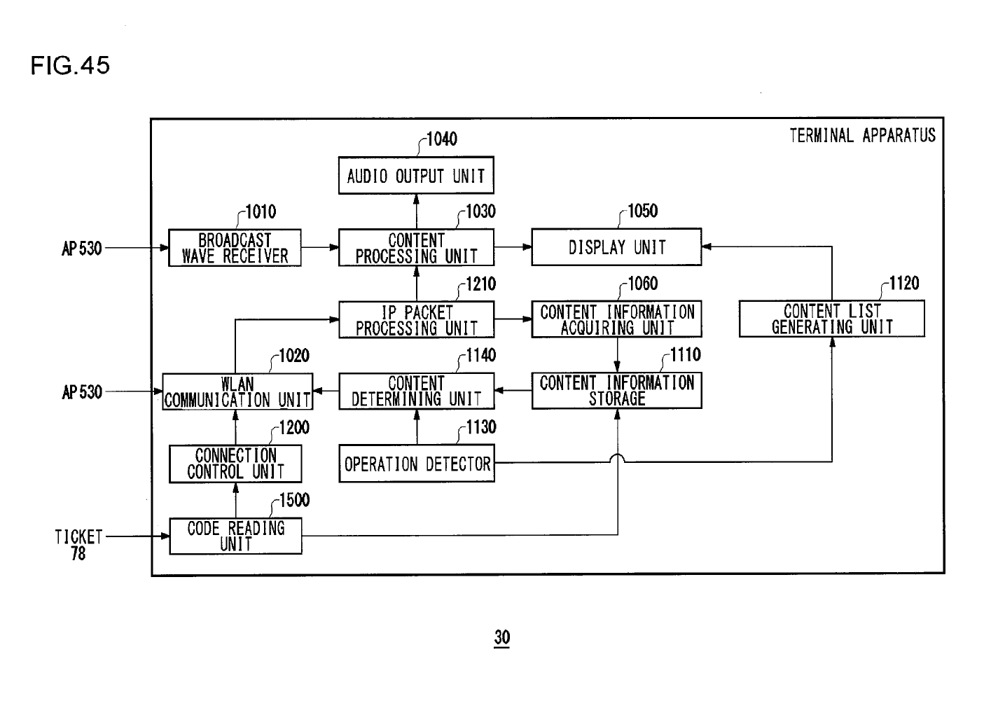

FIG. 45 is a diagram showing an exemplary structure of the terminal apparatus 30 of FIG. 43. The terminal apparatus 30 includes an audio output unit 1040, a broadcast wave receiver 1010, a content processing unit 1030, a display unit 1050, an IP packet processing unit 1210, a content information acquiring unit 1060, a content list generating unit 1120, a WLAN communication unit 1020, a content determining unit 1140, a content information storage 1110, a connection control unit 1200, an operation detector 1130, and a code reading unit 1500.

Of these structural components, the broadcast wave receiver 1010, the content processing unit 1030, the audio output unit 1040, the display unit 1050, the IP packet processing unit 1210, the content information acquiring unit 1060, the content list generating unit 1120, the WLAN communication unit 1020, the connection control unit 1200, the operation detector 1130 and the content determining unit 1140 function similarly to those in the other modifications, and therefore the description thereof is omitted here.

The code reading unit 1500 reads the QR code printed on the ticket 78 and thereby acquires connection setting information with which to connect to the content distribution apparatus 540 or AP 530, destination information on destinations and information on a vehicle or train the user will ride. Of these pieces of information acquired, the connection setting information is outputted to the connection control unit 1200. The destination information is stored in the content information storage 1110.

The content information storage 1110 stores the content information and the destination information. The destination information, which is information acquired by the code reading unit 1500, is destination information associated with the ticket. On the other hand, the content information is almost the same as that described in other examples and, in addition, the priority level is appended thereto and the priority level of an information content associated with the destination information stored therein is set to a higher level. Further, the content which had once been viewed and listened to may be given a higher priority level. According to this modification, the user's convenience can be enhanced.

(Ninth Modification)

Next, a description will be given of a ninth modification. Note that the components identical to those in the above-described embodiment or modifications are given the identical reference numerals, and the descriptions thereof are simplified. Firstly, an outline explanation is given. The ninth modification relates to a ninth distribution system.

This ninth modification is a modification to the eighth medication and is a system where the contents that the user captures and distributes using his/her originating terminal apparatus are shared by all users. This ninth modification is suited for installation in a baseball stadium and the like, and this ninth modification makes it possible to confirm images that otherwise cannot be confirmed from his/her own position.

The ninth modification is almost the same as the eighth modification but differs therefrom in the following features. The independent content distributed by the originating terminal apparatus are received only by specific terminal apparatuses whose address information has been conveyed through short-distance radio communication and the like. In contrast thereto, this ninth modification makes it possible that the independent content distributed by the originating terminal apparatus is viewed and listened to by all terminal apparatuses, and the encryption and the decoding processing of the independent content carried out in the eighth modification is not performed. Also, a channel distributed in real time and a channel distributed with a certain delay time (ten seconds, for example) are provided as the independent content. This enables the confirmation of what happened a few moments ago.

The originating terminal apparatus transmits its own positional information to the content distribution apparatus at regular intervals and reflects its content in the content information, so that where the image of the content has been taken can be clarified. To show this positional information simply and clearly to the users, the position of the originating apparatus is indicated on a map on the screen instead of the content list being displayed thereon, and an item that a user wishes to view is selected from thereamong. As a result, an originating apparatus associated with that point can receive, reproduce and view the delivered content.

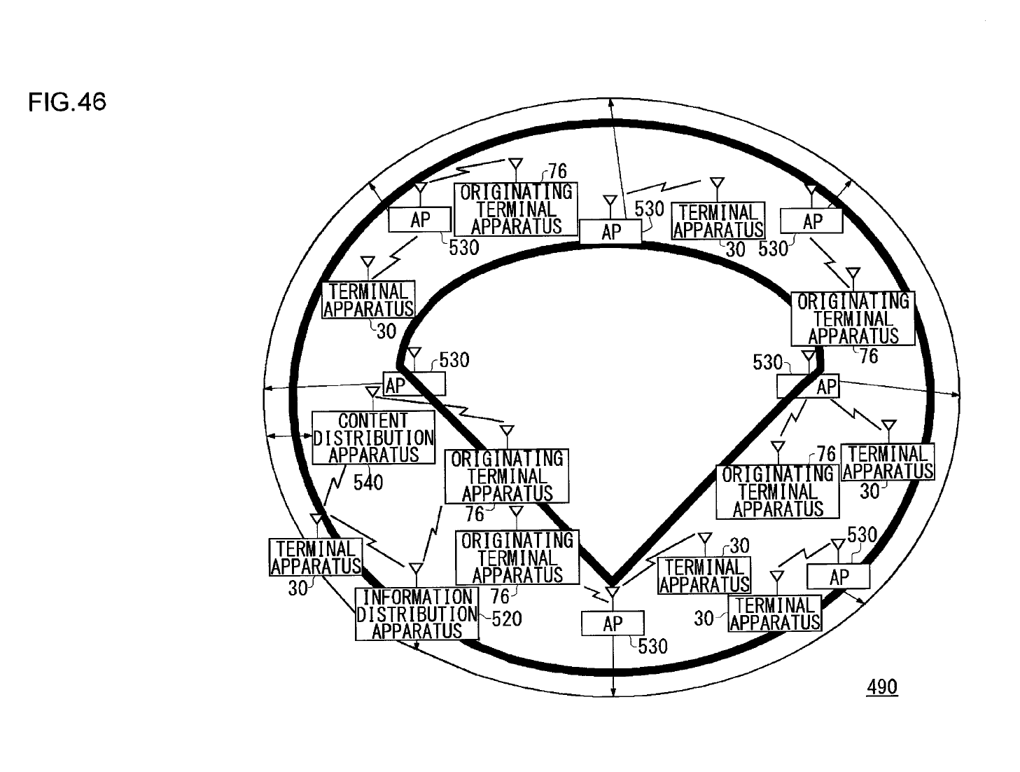

FIG. 46 is a diagram showing an exemplary structure of a ninth distribution system 490 according to a ninth modification. The ninth distribution system 490 includes an information distribution apparatus 520, an AP 530, a content distribution apparatus 540, a terminal apparatus 30, and an originating terminal apparatus 76. In the ninth distribution system 490, the terminal apparatus 30 and the originating terminal apparatus 76 acquire connection setting information from the information distribution apparatus 520, in a set area set near the entrance to the baseball stadium. Based on the thus acquired information, the ninth distribution system 490 connects to the content distribution apparatus 540. Then, as the terminal apparatus 30 and the originating terminal apparatus 76 move, the access point is changed to the nearest AP 530 according to the movement.

Similar to the above-described modification, the originating terminal apparatus 76 acquires an address used for multicast distribution, from the content distribution apparatus 540. The content distribution apparatus 540 distributes the content information by multicast. The content information in the ninth modification includes a content ID, a content name, address information and positional information. At regular intervals, the originating terminal apparatus 76 notifies the content distribution apparatus 540 of its own positional information such as GPS information, so that the content distribution apparatus 540 can keep track of the position of each originating terminal apparatus 76.

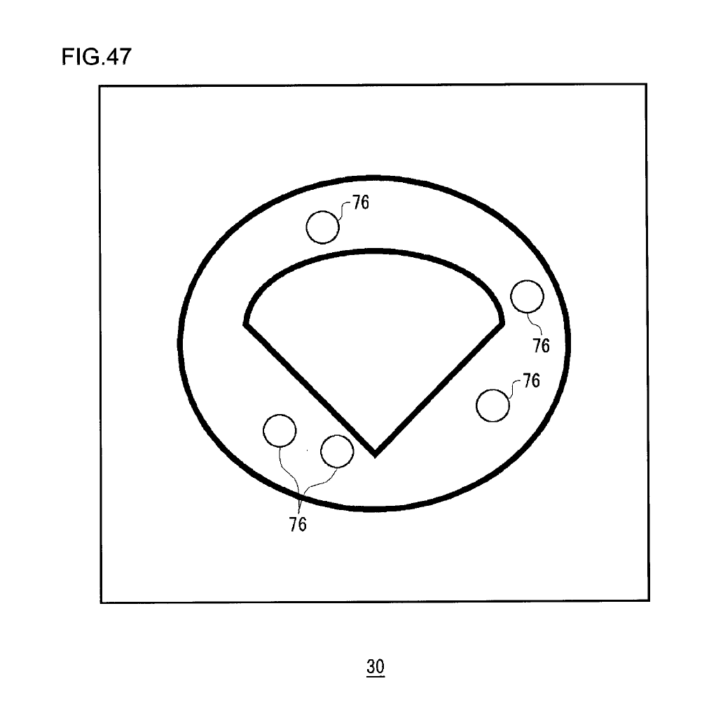

The terminal apparatus 30 generates a content list based on the content information. FIG. 47 is a diagram showing an exemplary display of screen of the terminal apparatus 30 of FIG. 46. As shown in FIG. 47, the locations of the originating terminal apparatuses 76 in FIG. 46 are displayed on the map showing the baseball stadium, on the screen of the terminal apparatus 30. As the user selects one of the originating terminal apparatuses 76, the content sent from an originating terminal apparatus 76 associated with said location can be received and reproduced.

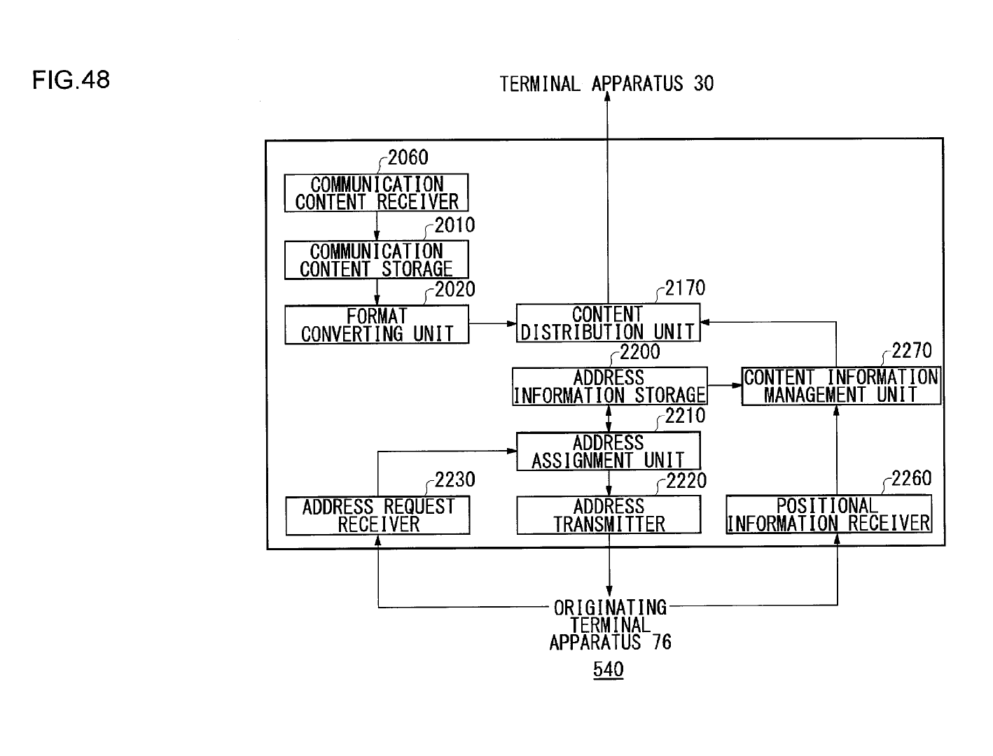

FIG. 48 is a diagram showing an exemplary structure of the content distribution apparatus 540 of FIG. 46. The content distribution apparatus 540 includes a communication content receiver 2060, a communication content storage 2010, a format converting unit 2020, a content distribution unit 2170, an address information storage 2200, a content information management unit 2270, an address assignment unit 2210, an address request receiver 2230, an address transmitter 2220, and a positional information receiver 2260.

Of these structural components, the communication content receiver 2060, the communication content storage 2010, the format converting unit 2020, the content distribution unit 2170, the address request receiver 2230, the address assignment unit 2210, the address transmitter 2220 and the address information storage 2200 are similar to those of the seventh modification, and therefore the description thereof is omitted here.

The positional information receiver 2260 receives the positional information transmitted periodically from the originating terminal apparatuses 76, outputs their contents to the content information management unit 2270, and requests it to update the content information. The content information management unit 2270 generates content information and carries out update processing. In concrete terms, the content information is generated and updated based on the address information stored in the address information storage 2200 and the positional information received from the positional information receiver 2260. The content information managed is distributed to the content distribution unit 2170 by multicast.

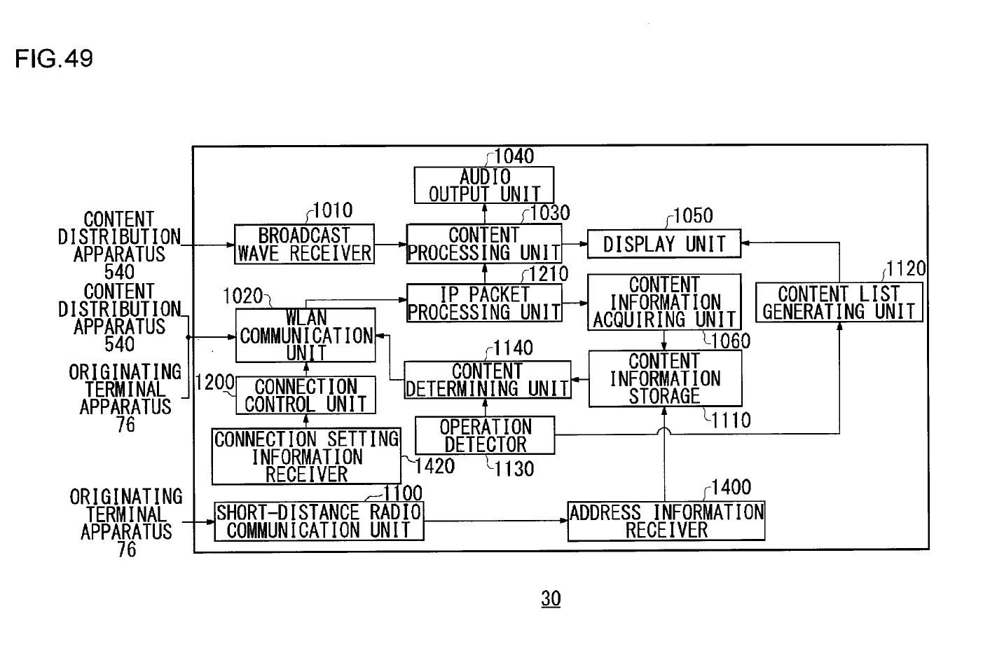

FIG. 49 is a diagram showing an exemplary structure of the terminal apparatus 30 of FIG. 46. The terminal apparatus 30 according to the ninth modification is almost identical to the terminal apparatus 30 according to the seventh modification. However, as described above, the only difference from the seventh modification lies in the method for displaying the content list. And the display unit 1050 display a map on the screen and displays on the map the position of an originating terminal apparatus 76 which is the distribution source. The other features are similar to those of the seventh modification and therefore the description thereof is omitted here.

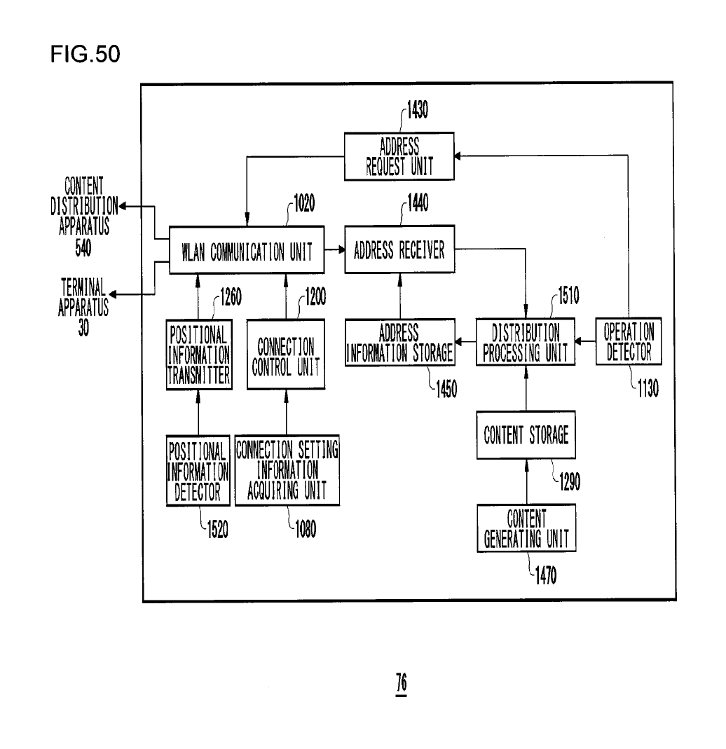

FIG. 50 is a diagram showing an exemplary structure of an originating terminal 76 apparatus of FIG. 46. The originating terminal apparatus 76 includes an address request unit 1430, a WLAN communication unit 1020, an address receiver 1440, a positional information transmitter 1260, a connection control unit 1200, an address information storage 1450, a distribution processing unit 1510, an operation detector 1130, a positional information detector 1520, a connection setting information acquiring unit 1080, a content storage 1290, and a content generating unit 1470.

Of these structural components, the WLAN communication unit 1020, the address request unit 1430, the address receiver 1440, the connection control unit 1200, the address information storage 1450, the distribution processing unit 1510, the operation detector 1130, the connection setting information acquiring unit 1080, the content storage 1290 and the content generating unit 1470 are similar to those included in the originating terminal apparatus 76 according to the seventh modification, and therefore the description thereof is omitted here. The address information transmitter and the short-distance radio communication unit included in the originating terminal apparatus 76 according to the seventh modification are not provided in this ninth modification.

The positional information detector 1520 periodically detects the positional information of its own terminal apparatus 30. The thus detected positional information is sent to the positional information transmitter 1260. The positional information transmitter 1260 transmits the positional information detected by the positional information detector 1520, to the content distribution apparatus 540 via the WLAN communication unit 1020.

(Tenth Modification)

Next, a description will be given of a tenth modification. Note that the components identical to those in the above-described embodiment or modifications are given the identical reference numerals, and the descriptions thereof are simplified. Firstly, an outline explanation is given. The tenth modification relates to a tenth distribution system. In the tenth modification, it is possible to control the content distribution apparatus from an external control server through an external network. According to this modification, a plurality of content distribution apparatuses can be managed, in a unified manner, from the external control server. The tenth distribution system is suited for application to a convenience store system having a plurality of stores, for instance.

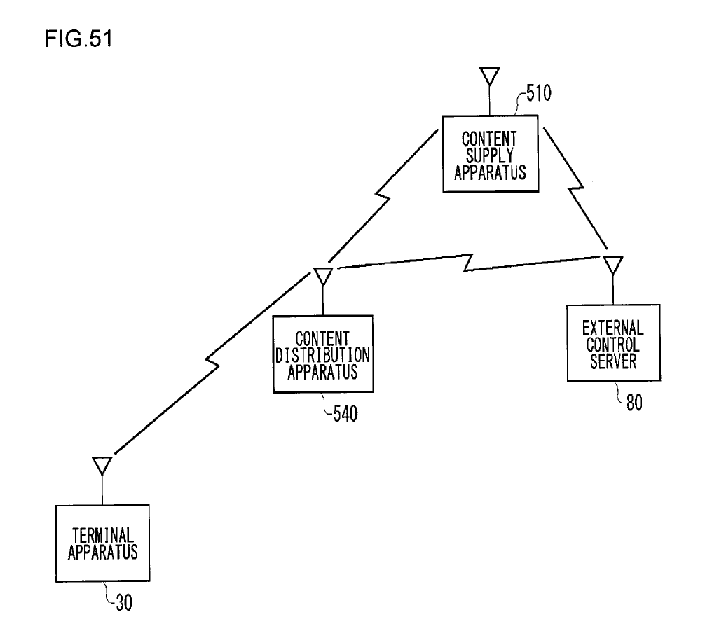

FIG. 51 is a diagram showing an exemplary structure of a tenth distribution system 500 according to the tenth modification. The tenth distribution system 500 includes a content distribution apparatus 540, a terminal apparatus 30, an external control server 80, and a content supply apparatus 510. The terminal apparatus 30 and the content supply apparatus 510 according to the tenth modification are similar to those in the other examples and therefore the description thereof is omitted here.

The external control server 80 remote-controls the content distribution apparatus 540 through an external network. Specifically, the external control server 80 specifies which kind of contents the content distribution apparatus 540 is to distribute or instructs it to acquire the contents held by the content supply apparatus 510. Also, the external control server 80 can acquire and display the distribution status of the content distribution apparatus 540. Looking at this display, a user who is a system administrator managing the tenth distribution system 500 enters an instruction to the content distribution apparatus 540.

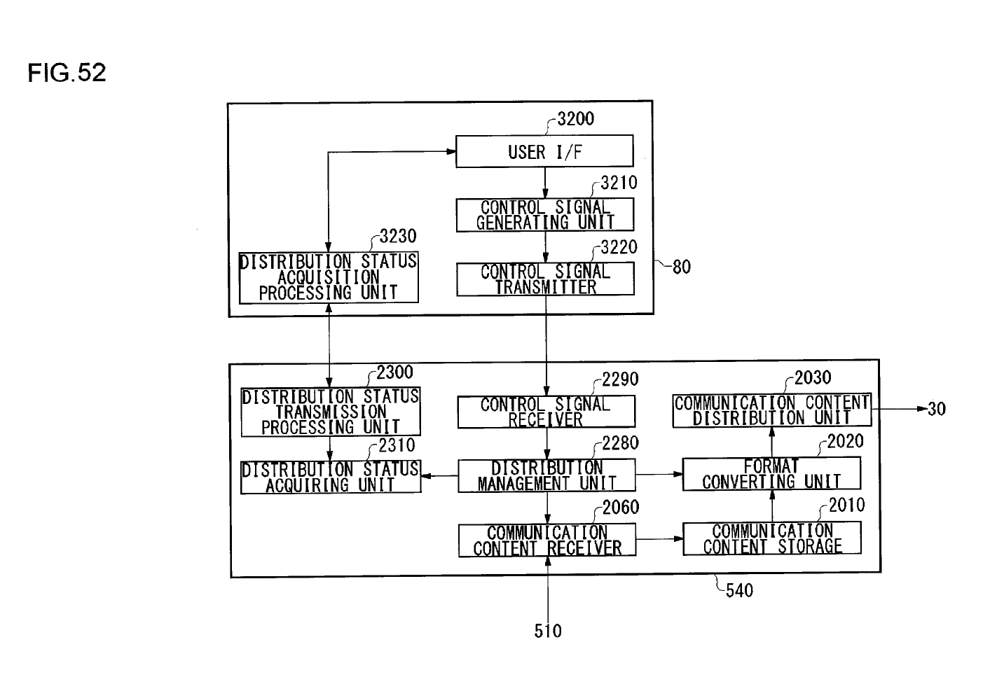

FIG. 52 is a diagram showing an exemplary structure of the external control server 80 and the content distribution apparatus 540 of FIG. 51. As shown in FIG. 52, the external control server 80 includes a user I/F 3200, a control signal generating unit 3210, a control signal transmitter 3220, and a distribution status acquisition processing unit 3230.

The user I/F 3200 carries out processing according to an instruction content entered by the user, and coveys the information to the user. Specifically, as the user enters an instruction to display the distribution status into the user I/F 3200, the distribution status acquisition processing unit 3230 is requested to acquire the distribution status, of the content distribution apparatus 540, instructed by the user. In response to this request, the distribution status acquisition processing unit 3230 displays the thus acquired distribution status. As the user enters a control instruction to the content distribution apparatus 540, the control signal generating unit 3210 is requested to generate the control signal according to the instruction content thereof.

The distribution status acquisition processing unit 3230, which receives a request from the user I/F 3200, acquires a distribution status of the content distribution apparatus 540. Specifically, the distribution status acquisition processing unit 3230 requests the content distribution apparatus 540 associated with an instruction from the user I/F 3200, to indicate the distribution status. The thus acquired distribution status is sent to the user I/F 3200 and then conveyed to the user.

The control signal generating unit 3210 generates a control signal associated with a control instruction entered by the user I/F 3200. There are two kinds of control signals. One is a control signal that instructs to acquire a content from the content supply apparatus 510, and this control signal includes an ID by which to identify the content supply apparatus 510, device information on the content distribution apparatus 540, and an content ID. The other one is a control signal that specifies a content which is to be multicast-distributed by the content distribution apparatus 540, and is content information on a content to be distributed by the content distribution apparatus 540.

The content information includes a content ID, a content name, an IP address, and a channel. The content information may further include the indication of a time period during which the content must be delivered, such as “9:00 to 13:00”. In such a case, a distribution schedule can be set beforehand. The control signal generated by the control signal generating unit 3210 is sent to the control signal transmitter 3220. The control signal transmitter 3220 transmits the control signal generated by the control signal generating unit 3210, to the corresponding content distribution apparatus 540.

A description is now given of the content distribution apparatus 540. The content distribution apparatus 540 includes a distribution status transmission processing unit 2300, a distribution status acquiring unit 2310, a control signal receiver 2290, a distribution management unit 2280, a communication content distribution unit 2030, a format converting unit 2020, a communication content storage 2010, and a communication content receiver 2060. Of these components, the communication content receiver 2060, the communication content storage 2010, the format converting unit 2020, and the communication content distribution unit 2030 are similar to those of the above-described content distribution apparatus 540, and therefore the description thereof is omitted here.

The control signal receiver 2290 receives the control signal transmitted from the external control server 80. The control signal thus received is sent to the distribution management unit 2280. The distribution management unit 2280 executes the control signal received from the control signal receiver 2290. If the received control signal indicates the acquisition of a content from the content supply apparatus 510, the distribution management unit 2280 will request the communication content receiver 2060 to acquire the corresponding content. If, on the other hand, the received control signal indicates a content to be distributed, it will request the format converting unit 2020 to process said content according to its indication content. If the indication includes an instruction as to distribution time, the indication will be saved and its content will be executed when the instructed time comes.

Based on a request from the distribution status acquiring unit 2310, the distribution status acquiring unit 2310 acquires information concerning the contents being currently distributed and those scheduled to be distributed, from the distribution management unit 2280. The distribution status thus acquired is sent to the distribution status transmission processing unit 2300. When the external control server 80 requests the distribution status transmission processing unit 2300 to submit the distribution status, the distribution status transmission processing unit 2300 requests the distribution status acquiring unit 2310 to acquire the distribution status. In response thereto, the distribution status acquired by the distribution status acquiring unit 2310 is transmitted to the external control server 80.

The present invention has been described based on the exemplary embodiment. The exemplary embodiment is intended to be illustrative only, and it is understood by those skilled in the art that various modifications to constituting elements and processes could be developed and that such modifications are also within the scope of the present invention.

### INDUSTRIAL APPLICABILITY

The present invention enables easy acquisition of contents.

1. A terminal apparatus, comprising:
a receiver which receives communication data in a format prescribed in a communication system, from a base station apparatus in the communication system; and
a reproduction unit which reproduces broadcast data in a format prescribed for broadcasting in another broadcasting system which differs from the communication system,
wherein the communication data received by said receiver contains the broadcast data, and
wherein said reproduction unit extracts the broadcast data from the communication data received by said receiver, and reproduces the extracted broadcast data.

2. A terminal apparatus according to claim 1, further comprising:
an acquiring unit which acquires connection information with which to connect to the base station, from a communication apparatus; and
a connection processing unit which establishes a connection to the base station apparatus, using the connection information acquired by said acquiring unit,
wherein after the connection has been establish by said connection processing unit, said receiver receives the communication data from the base station apparatus.

3. A terminal apparatus, comprising:
an acquiring unit which acquires connection information with which to establish a connection between said terminal apparatus and a base station apparatus wherein the connection information has been transmitted from a communication apparatus;
a connection processing unit which carries out a connection processing between said terminal apparatus and the base station apparatus, using the connection information acquired by said acquiring unit; and
a receiver which receives communication data from the base station apparatus after the connection processing by said connection processing has been completed.

4. A terminal apparatus according to claim 2 or claim 3, wherein the connection information acquired by said acquiring unit contains area information on an area where said terminal apparatus is located, and
wherein said receiver switches the communication data to be received, according to the area information acquired by said acquiring unit.

5. A communication system, comprising:
a base station apparatus which transmits communication data;
a communication apparatus which broadcasts connection information with which to connect to said base station apparatus; and
a terminal apparatus which carries out a connection processing between said terminal apparatus and said base station apparatus according to the connection information transmitted from said communication apparatus and which acquires communication data from the connected base station apparatus.

6. A communication method wherein communication data in a format prescribed in a communication system are received from a base station apparatus in the communication system, the communication data containing broadcast data in a format prescribed for broadcasting in another broadcasting system which differs from the communication system,
the broadcast data are extracted from the received communication data, and
the extracted broadcast data are reproduced.

7. A communication method, wherein connection information transmitted from a communication apparatus is acquired, the connection information being used to establish a connection to a base station apparatus different from the communication apparatus,
a connection processing with the base station apparatus is carried out using the acquired connection information, and
communication data are received from the base station apparatus after the connection processing has been completed.
